(19) United States
(12) Patent Application Publication
(10) Pub. No.: US 2022/0188678 A1
(43) Pub. Date: Jun. 16, 2022

(54) COMPUTER-READABLE RECORDING MEDIUM STORING OPTIMIZATION PROGRAM, OPTIMIZATION METHOD, AND INFORMATION PROCESSING APPARATUS

(71) Applicant: FUJITSU LIMITED, Kawasaki-shi (JP)

(72) Inventors: Daisuke Kushibe, Kawasaki (JP); Yasuhiro Watanabe, Kawasaki (JP)

(73) Assignee: FUJITSU LIMITED, Kawasaki-shi (JP)

(21) Appl. No.: 17/491,581

(22) Filed: Oct. 1, 2021

(30) Foreign Application Priority Data
Dec. 15, 2020 (JP) 2020-207438

(51) Int. Cl. G06N 7/00

(52) U.S. Cl. CPC G06N 7/005

(57) ABSTRACT

A recording medium stores an optimization program for causing a computer to execute a process including: acquiring information on an evaluation function obtained by converting a problem; determining values of temperature parameters used for solution processing of an optimal solution by a replica exchange method; setting each of values of the temperature parameters to any one of replicas; and executing the solution processing by performing, for each of the replicas, update processing of repeating update of any value of state variables included in the evaluation function in accordance with a first transition probability, and repeating exchange processing of exchanging, between the replicas, any values of the temperature parameters set for each of the replicas or values of the state variables in each of the replicas, in accordance with an exchange probability that satisfies an invariant distribution condition of probability distribution obtained by the first transition probability.

### CROSS-REFERENCE TO RELATED APPLICATION

This application is based upon and claims the benefit of priority of the prior Japanese Patent Application No. 2020-207438, filed on Dec. 15, 2020, the entire contents of which are incorporated herein by reference.

### FIELD

The embodiments discussed herein are related to a computer-readable recording medium storing an optimization program, an optimization method, and an information processing apparatus.

### BACKGROUND

As a problem that frequently occurs in natural science and social science, there is a minimum value solution problem (or referred to as a combination optimization problem) of searching for a minimum value (or a combination of values of state variables of an evaluation function (also referred to as an energy function) giving a minimum value) of an evaluation function as an optimal solution. There is also a case in which, by changing the sign of an evaluation function, a maximum value of the evaluation function may be searched for as an optimal solution. In recent years, the movement of formulating such a problem by using the Ising model that is a model indicating behaviors of spins of magnetic substances has been accelerated. A technical basis of this movement is achievement of Ising-type quantum computers. The Ising-type quantum computer is expected to solve a multivariate combinatorial optimization problem which the Neumann-type computer is not good at in a realistic time. On the other hand, an optimization device in which an Ising-type computer is implemented by an electronic circuit has also been developed.

Japanese Laid-open Patent Publication No. 2020-086821, Japanese Laid-open Patent Publication No. 2019-071119, Japanese Laid-open Patent Publication No. 2020-064536, Japanese Laid-open Patent Publication No. 2019-197355, and Japanese Laid-open Patent Publication No. 2018-067200 are disclosed as related art.

Sanroku Tsukamoto, Motomu Takatsu, Satoshi Matsubara and Hirotaka Tamura, “An Accelerator Architecture for Combinatorial Optimization Problems”, FUJITSU Sci. Tech. J., Vol. 53, No. 5, September 2017, pp. 8 to 13, S. Kirkpatrick, C. D. Gelatt, M. P. Vecchi, “Optimization by Simulated Annealing”, Science, Vol. 220, No. 4598, 13 May, 1983, pp. 671 to 680, Constantino Tsallis, Daniel A. Stariolo, “Generalized simulated annealing”, Physica A, 233, 1996, pp. 395-406, Koji Hukushima and Koji Nemoto, “Exchange Monte Carlo Method and Application to Spin Glass Simulations”, J. Phys. Soc. Jpn, Vol. 65, No. 6, June, 1996, pp. 1604-1608, Bemd A. Berg and Tarik Celik, “New Approach to Spin-Glass Simulations”, Phys. Rev. Lett, Vol. 69, No. 15, October, 1992, p. 2292, and T. J. P. Penna, “Traveling salesman problem and Tsallisstatistics”, Phys. Rev. E, Vol. 51, No. 1, R1, January, 1995, p. 51 are also disclosed as related art.

### SUMMARY

According to an aspect of the embodiments, a non-transitory computer-readable recording medium stores an optimization program for causing a computer to execute a process including: acquiring information on an evaluation function obtained by converting a problem; determining values of a plurality of temperature parameters that are different from each other and used for solution processing of an optimal solution by a replica exchange method; setting each of values of the plurality of temperature parameters to any one of a plurality of replicas; and executing the solution processing by performing, for each of the plurality of replicas independently of each other, update processing of repeating update of any value of a plurality of state variables included in the evaluation function in accordance with a first transition probability that is obtained based on an amount of change in a value of the evaluation function due to a change in any value of the plurality of state variables and any value of the plurality of temperature parameters, and in which a change in a value of the evaluation function relative to a change in a value of temperature parameter is gentler than that in a case of using a second transition probability based on the Boltzmann distribution, and repeating exchange processing of exchanging, between the plurality of replicas, any values of the plurality of temperature parameters set for each of the plurality of replicas or values of the plurality of state variables in each of the plurality of replicas, in accordance with an exchange probability that satisfies an invariant distribution condition of probability distribution obtained by the first transition probability.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an information processing apparatus according to a first embodiment;

FIG. 2 is a diagram illustrating an example of a change of energy by temperature in a case where a transition probability based on the Boltzmann distribution is used;

FIG. 3 is a diagram illustrating an example of a relationship between the number of states and division of energy section for physical quantity A;

FIG. 4 is a diagram illustrating an example of a difference in temperature dependence of energy between a case of using a transition probability based on the Boltzmann distribution and a case of using an exponentiation type transition probability;

FIG. 5 is a diagram Illustrating an example of a relationship between an exponent of an exponentiation type transition probability and temperature dependence of energy (expected value);

FIG. 6 is a diagram Illustrating probability density distribution in an energy space obtained in a replica for which each value of temperature parameter is set;

FIG. 7 is a diagram Illustrating probability density distribution in an energy space obtained when replica exchange is performed;

FIG. 8 is a diagram illustrating a calculation example of the maximum cut problem by the replica exchange method;

FIG. 9 is a schematic diagram illustrating an example of detailed balance in the replica exchange method;

FIG. 10 is a diagram illustrating an example of replica exchange only between adjacent temperature parameters;

FIG. 11 is a diagram illustrating an example of energy that gives a vertex of probability density distribution in an energy space and a standard deviation of the probability density distribution;

FIG. 12 is a diagram illustrating an example of behavior of probability density distribution in a low temperature region;

FIG. 13 is a diagram illustrating a hardware example of an information processing apparatus according to a second embodiment;

FIG. 14 is a block diagram illustrating a function example of the Information processing apparatus according to the second embodiment;

FIG. 15 is a flowchart illustrating an example of a flow of processing by the information processing apparatus according to the second embodiment;

FIG. 16 is a flowchart illustrating an example of a flow of information reading processing;

FIG. 17 is a flowchart illustrating an example of a flow of spin initialization processing;

FIG. 18 is a flowchart illustrating an example of a flow of temperature parameter calculation processing;

FIG. 19 is a flowchart illustrating an example of a flow of probability density calculation processing;

FIG. 20 is a flowchart illustrating an example of a flow of probability density update processing;

FIG. 21 is a flowchart illustrating an example of a flow of update processing of Eₘᵢₙ and Eₘᵢₓ;

FIG. 22 is a flowchart illustrating an example of a flow of replica exchange processing;

FIG. 23 is a diagram illustrating a state of exchanging the values of temperature parameter;

FIG. 24 is a diagram illustrating a change in the value of temperature parameter set for a replica; and

FIG. 25 is a diagram illustrating an example of a result of comparison of tunneling time in replica exchange processing between the case of using a transition probability based on the Boltzmann distribution and the case of using an exponentiation type transition probability.

### DESCRIPTION OF EMBODIMENTS

As a method of calculating a minimum value solution problem using the Ising model, there is a method of Introducing a temperature parameter indicating a pseudo temperature based on a Markov chain Monte Carlo method (hereinafter referred to as an MCMC method) and gradually decreasing temperature from a high temperature. This method is called a simulated annealing method (hereinafter abbreviated as SA method). The SA method is a method theoretically guaranteed to reach an optimal solution. However, the SA method is a method of lowering a temperature in accordance with the reciprocal of a logarithm, and is not practical. Therefore, an exponentiation type annealing schedule that is faster than the reciprocal of a logarithm is practically used in many cases, but in such case, reaching the minimum value is not guaranteed. In a case where an annealing schedule that is faster than the reciprocal of a logarithm is used, there is a disadvantage of not being able to escape from a local minimum value once a state gets caught in the local minimum value.

There is a replica exchange method as an algorithm in consideration of this disadvantage. In the replica exchange method, a large number of same simulation boxes (called replicas) that differ only in temperature are prepared, and temperatures are exchanged between replicas that satisfy an exchange condition at a fixed frequency. As a result of exchange, each replica randomly walks in a temperature space. As a result, a state may escape from a deep local minimum value of energy in a high temperature region, and the solution efficiency is improved.

On the other hand, the replica exchange method also has a disadvantage. Since the replica exchange method is a method originally developed in the fields of condensed matter physics and computational chemistry, a transition probability inside a replica is specified based on the Boltzmann distribution. Probability distribution of each replica is maintained to be the Boltzmann distribution even when replica exchange is performed. This condition is called an invariant distribution condition. The reason why the Invariant distribution condition is imposed is that calculation of physical quantities is assumed in statistical physics. A problem with the replica exchange method is that as the degree of freedom of a system increases, the number of replicas used increases in proportion to the square root of N (the degree of freedom) as a function of N.

In a case where there is a phase transition in which the value (energy) of an evaluation function abruptly changes with respect to a temperature change, replica exchange may not function properly, and the interval for temperature parameters has to be set more precisely, which is a burden on a calculating person. This is tendency becomes stronger as the degree of freedom increases.

A multicanonical method has been proposed as an algorithm that overcomes this disadvantage. The multicanonical method is a method for trying to solve the above-described disadvantage by building an algorithm so as to visit an energy space with an equal probability instead of a temperature space, and is also called a flat histogram method. However, the multicanonical method also has a disadvantage. A large amount of preliminary calculation has to be done to create a flat histogram. A flat histogram may not be obtained at all times. Even if the amount of calculation is increased, a flat histogram may not be obtained. Therefore, much effort is spent on preliminary calculation.

As described above, when the replica exchange method is used as a method of searching for an optimal solution, it is difficult to determine appropriate temperature parameters for Increasing the solution efficiency while expanding a sampling space and obtaining a broader solution.

In one aspect, an optimization program, an optimization method, and an information processing apparatus that facilitate determination of the values of a plurality of temperature parameters in the replica exchange method may be provided.

Hereinafter, embodiments of the present disclosure are described with reference to the drawings.

### First Embodiment

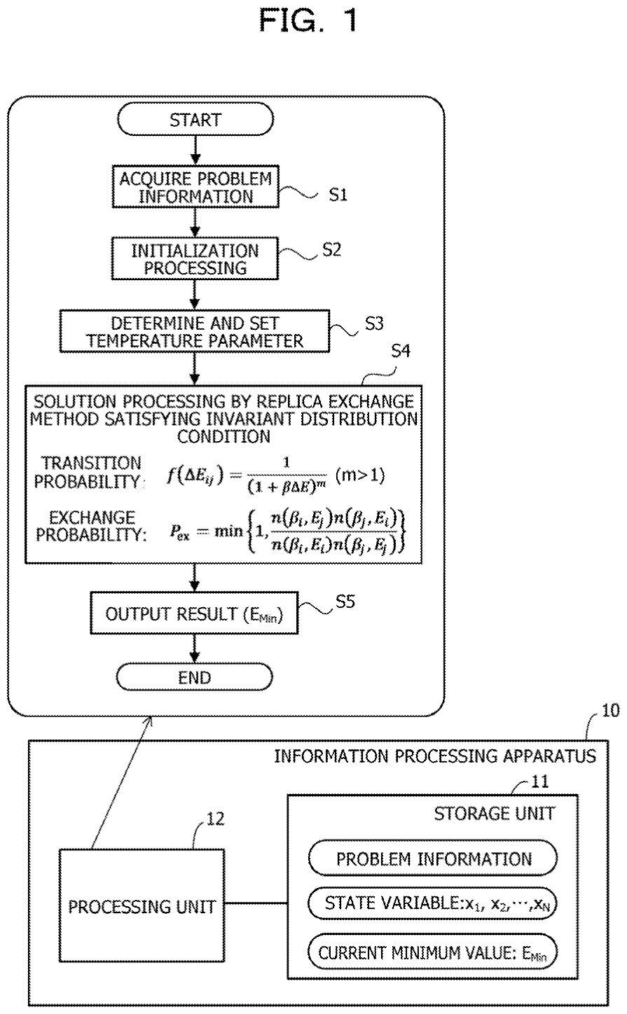

FIG. 1 is a diagram Illustrating an example of an information processing apparatus according to a first embodiment.

An information processing apparatus 10 includes a storage unit 11 and a processing unit 12.

The storage unit 11 stores information of an evaluation function (hereinafter referred to as an energy function) obtained by converting a problem (hereinafter referred to as problem information). The storage unit 11 stores the values of state variables included in the evaluation function, the current minimum value (minimum energy (E_{Min})) of the value of the evaluation function (hereinafter referred to as energy) corresponding to the values of the state variables, and other values. Since the processing unit 12 searches for an optimal solution of a problem (for example, the minimum value of an energy function) by the replica exchange method as described later, the values of state variables and energy are stored for each replica. The storage unit 11 is a volatile storage device such as a random-access memory (RAM) or a non-volatile storage device such as a hard disk drive (HDD) or a flash memory.

The processing unit 12 performs solution processing of an optimal solution by the replica exchange method. The processing unit 12 is a processor such as a central processing unit (CPU), general-purpose computing on graphics processing units (GPGPU), or a digital signal processor (DSP). However, the processing unit 12 may include an application-specific electronic circuit such as an application-specific integrated circuit (ASIC) and a field-programmable gate array (FPGA). The processor executes a program stored in a memory such as a RAM. For example, an optimization program is executed. A set of a plurality of processors may be referred to as a “multiprocessor” or simply a “processor”.

By the replica exchange method, the processing unit 12 searches for, for example, the minimum value of an Ising-type energy function obtained by converting a problem (or a combination of the values of state variables with which the minimum value is obtained).

An Ising-type energy function (H({x})) is defined by, for example, the following equation (1).

H({x})=−Σₗ₌₁^{N}Σ_{j>l}^{N}Wᵢⱼxᵢxⱼ−Σᵢ₌₁^{N}bᵢxᵢ−C (1)

The first term on the right side adds up the products of the values of two state variables (0 or 1) and a weight coefficient without omission and duplication for all combinations of N state variables. xᵢ represents an i-th state variable, xⱼ represents a j-th state variable, and Wᵢⱼ is a weight coefficient indicating the magnitude of interaction between xᵢ and xⱼ. The second term on the right side is a sum of the products of a bias coefficient (b) of each state variable and the value of each state variable. The third term (C) on the right side is a constant.

The weight coefficient (Wᵢⱼ), the bias coefficient (bᵢ), and the constant (C) are stored in the storage unit 11 as problem information.

Symbols are defined as follows. First, there are a discrete finite number of states obtained by combinations of N state variables from equation (1). When the total number of states is M, M=2^{N}. When the number of states having different values of energy is M_{E}, M_{E}≤2^{N}. The values of energy are described as E₀, E₁, . . . , Eₖ, . . . , E_{ME} in ascending order. A set of N xᵢ that gives Eₖ is described as {xₖ}. Therefore, H({xₖ})=Eₖ. In this case, the degree of degeneracy is Mₖ. In many cases, there are a plurality of combinations of state variables that give the same energy.

An amount of change in the value of an energy function due to a change in the value of xₖ, which is one of the state variables (energy difference (ΔEₖ)) may be represented as ΔEₖ=−(1−2xₖ)hₖ. 1−2xₖ represents an amount of change in xₖ (Δxₖ). When xₖ changes from 1 to 0, 1−2xₖ=−1. When xₖ changes from 0 to 1, 1−2xₖ=1. hₖ is called a local field and may be represented by the following equation (2).

hₖ=Σ_{i=1,i=k}^{N}Wₖᵢxᵢ+bₖ (2)

When searching for the minimum value of an energy function as described above, the processing unit 12 uses the replica exchange method.

In the replica exchange method, a plurality of replicas, in each of which the value of an energy function defined by equation (1) is calculated, is prepared. A temperature parameter set for the replica with replica number=i is Tᵢ. In each replica, a certain number of times of MCMC calculation is performed by using the value of a fixed temperature parameter (the above-described pseudo temperature). Every certain number of times, the values of temperature parameter between replicas is exchanged based on a predetermined exchange probability. Instead of exchanging the values of temperature parameter, states (the values of N state variables) may be exchanged.

In MCMC calculation, the processing unit 12 generates a state transition according to a predetermined transition probability. At this time, a state transition in which energy increases is allowed with a certain probability. This is known as the Metropolis method. When the Boltzmann distribution is used as in the related art, a transition probability in the Metropolis method may be represented as P_{i→j}=min(1, exp(−βΔE)). P_{i→j} is a transition probability between a state i before the state transition and a state j after the state transition by randomly selecting one state variable from the state variables in the state i and inverting the state variable. β is a value of temperature parameter set for each replica (in this case, a reciprocal of a temperature (referred to as an Inverse temperature)), and the inverse temperature in the replica with replica number=i is βᵢ=1/Tᵢ.

In a case where a transition probability based on the Boltzmann distribution is used as in the related art, an exchange probability in the replica exchange method may be represented by the following equation (3).

$${P}_{A \to B} = min \{ 1 , \frac{{P}_{B} ( t )}{{P}_{A} ( t )} \} = min \{ 1 , exp ( Δβ \cdot Δ E ) \} \qquad ( 3 )$$

In equation (3), P_{A}(t) is a probability that a state A before replica exchange is realized. P_{B}(t) is a probability that a state B after replica exchange is realized. Δβ is a difference between the inverse temperature (βⱼ) set in the replica with replica number=j and the Inverse temperature (βⱼ) set in the replica with replica number=i, and Δβ=βⱼ−βᵢ. ΔE is a difference between the energy (Eⱼ) of the replica with replica number=j and the energy (Eᵢ) of the replica with replica number=1, and ΔE=Eⱼ−Eᵢ.

For example, in the replica exchange method, the values of temperature parameter are exchanged with a probability determined by the product of inverse temperature difference and energy difference between replicas. In the replica exchange method, by exchanging the values of temperature parameter, each replica randomly walks in a temperature space. As a result, a state may go through a high temperature region, and even when caught in a local minimum state having a deep local minimum value of energy, the state may to easily escape therefrom.

However, in the replica exchange method, when an exchange probability is represented by equation (3) based on the Boltzmann distribution, the exchange probability exponentially decreases as the energy difference between two replicas increases.

Therefore, there is a limit on the setting of temperature parameters. The interval for temperature parameters has to be approximately 1/square root of N, and the number of replicas has to be approximately square root of N. This means that the number of replicas increases when the degree of freedom increases.

The following problem occurs regarding the setting of temperature parameters.

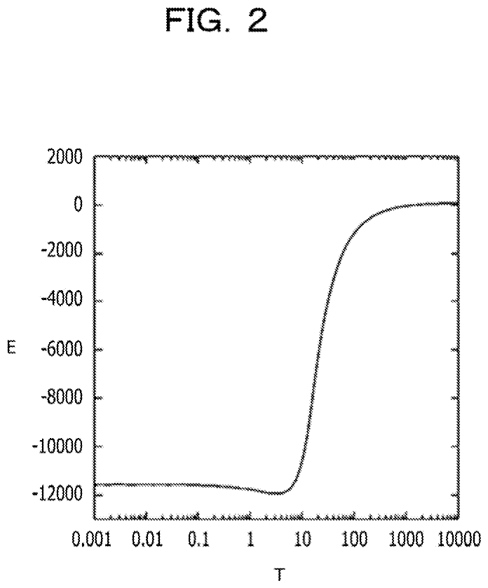

FIG. 2 is a diagram illustrating an example of a change of energy by temperature in a case where a transition probability based on the Boltzmann distribution is used. The horizontal axis represents temperature parameter (T), and the vertical axis represents energy (E).

FIG. 2 illustrates an example of a change of energy by temperature obtained when a certain problem is calculated. In the case of this example, an abrupt increase in energy is seen with respect to the value of temperature parameter in the range of 10<T<100. This is a phenomenon related to a phase transition. It is known that a phase transition does not occur in a system of a finite degree of freedom, but as the degree of freedom of a system increases, a change of energy by temperature rapidly occurs, and the characteristics of a phase transition become remarkable.

When such phase transition occurs, replica exchange does not function efficiently. For example, there are a group in which replica exchange occurs only in a region of values equal to or lower than the value of temperature parameter at which a phase transition occurs (hereinafter referred to as a transition temperature) and a group in which replica exchange occurs only in a region of values higher than the transition temperature. Therefore, in order to cause replica exchange to function as the degree of freedom increases, temperature interval for replicas in the vicinity of the transition temperature has to be more carefully selected.

This is because an exchange probability as in equation (3) is used. Equation (3) is formulated under the condition that probability distribution that each replica follows is maintained to be the Boltzmann distribution even when replica exchange is performed. Such condition is called an Invariant distribution condition. For example, the state A is a state in which the replica with replica number=i is ({xᵢ}, βᵢ) and the replica with replica number=j is ({xⱼ}, βⱼ). The state B is a state in which the replica with replica number=i is ({xⱼ}, βᵢ) and the replica with replica number=j is ({xᵢ}, βⱼ). A condition that replica exchange reaches a steady state, which is defined between any two replicas as that the probability distribution of the replicas does not change before and after the exchange, is given by the following equation (4).

$${P}_{A \to B} = min \{ 1 , \frac{n ( {B}_{i} , \{ {x}_{j} \} ) n ( {B}_{j} , \{ {x}_{i} \} )}{n ( {B}_{i} , \{ {x}_{i} \} ) n ( {B}_{j} , \{ {x}_{j} \} )} \} \qquad ( 4 )$$

In equation (4), π({xⱼ}, βⱼ) is statistical distribution that a system follows. When the Boltzmann distribution is used as π({xⱼ}, βⱼ), equation (3) is obtained as an equation of exchange probability.

In a case of dealing with a problem of a physical system such as a magnetic substance, the Boltzmann distribution has to be used. This is because a thermal equilibration state follows statistical distribution of exp(−βE). In a case where an entropy effect plays an important role in a thermodynamic behavior of a system, such as Helmholtz free energy or Gibbs free energy, an effect of entropy is appropriately incorporated, so that usable probability distribution is also limited.

However, since the problem of obtaining the minimum value of an energy function as in equation (1) expressed by the Ising model may be regarded simply as a minimum value solution problem of a function, it may not be limited to the Boltzmann distribution. If a phase transition is caused by the Boltzmann distribution and the phase transition reduces the efficiency of replica exchange, probability distribution with which the phase transition does not occur may be used.

When preliminary calculation is troublesome as in the multicanonical method, a calculation method that makes preliminary calculation easy may be used. As long as a Markov chain is irreducible, it is probabilistically guaranteed that the minimum value of a system is reached.

In order to avoid a phase transition phenomenon that occurs when the Boltzmann distribution is used, the processing unit 12 uses probability distribution that is not the Boltzmann distribution.

Hereinafter, a transition probability is not defined as P_{i→j}=min(1, exp(−βΔE)) as described above, but is defined by the following equation (5).

$${P}_{i \to j} = \{ \begin{matrix}1 & Δ {E}_{ij} \leq 0 \\ f ( Δ {E}_{ij} ) & Δ {E}_{ij} > 0\end{matrix} \qquad ( 5 )$$

In equation (5), a transition probability f(ΔEᵢⱼ) is an arbitrary function, but is determined to be finite, and satisfies f(ΔEᵢⱼ)<∞. As a boundary condition, the following equation (6) is requested.

$${lim}_{Δ {E}_{ij} \to 0} f ( Δ {E}_{ij} ) = 1 \qquad ( 6 )$$

It is assumed that the sum of probabilities of transition from the current state represented by the value of the current state variable to each of a plurality of different states is determined to be finite, and the condition of the following equation (7) is satisfied.

Σⱼ₌^{N}P_{i→j}=Bᵢ<∞ (7)

In equation (7), Bᵢ is, for example, Bᵢ=1. However, it is not limited to Bᵢ=1.

Next, replica exchange that satisfies the Invariant distribution condition under the transition probability defined by equation (5) is defined. Probability distribution π({xᵢ}, t) determined under the transition probability defined by equation (5) is determined by the master equation of the following equation (8).

$$\frac{d}{dt} n ( \{ {x}_{j} \} , t ) = {\sum }_{m = 1}^{M} {P}_{m \to j} n ( \{ {x}_{m} \} , t ) - {\sum }_{m = 1}^{M} {P}_{j \to m} n ( \{ {x}_{j} \} , t ) \qquad ( 8 )$$

π({xᵢ}, t) is uniquely present according to the definition of the transition probability of equation (5). This is because the transition probability for all ΔEᵢⱼ is not 0, and the transition probability for ΔEᵢᵢ=0, which is for a transition that does not change the state, is not 0. In equation (8), the steady state is given by the following equation (9).

$$\frac{d}{dt} n ( \{ {x}_{j} \} , t ) = 0 \qquad ( 9 )$$

Therefore, an equation to be satisfied by the steady state may be represented by the following equation (10).

Eₘ₌₁^{M}O_{m→j}π({xₘ})−Σₘ₌₁^{M}P_{j→m}π({xⱼ})=0 (10)

In the steady state, probability distribution does not depend on the time t, and thus may be expressed as π({xᵢ}) with t omitted. Probability distribution introduced by the transition probability of equation (5) may not satisfy the principle of detailed balance. The principle of detailed balance is a principle in which each term of the summation symbol in equation (10) is 0. When detailed balance is established, P_{m→j}π({xₘ})−P_{j→m}π({xⱼ})=0 holds, and thus the following equation 11 holds.

$$\frac{{P}_{m \to j}}{{P}_{j \to m}} = \frac{n ( \{ {x}_{j} \} )}{n ( \{ {x}_{m} \} )} \qquad ( 11 )$$

From equation (11), when probability distribution is a Boltzmann distribution type and exp(−βΔE) is used, the transition probability is P_{i→j}=min(1, exp(−βΔE)) described above. Although the principle of detailed balance is not established under the transition probability of equation (5), probability distribution functions have the same value when the same energy (E₀) is given to a set of two different state variables {xₖ} and {xₗ} (k≠l). For example, π({xₖ})=π({xₗ}) holds.

This is because of the following reason. Since E₀ is given to the set of two different state variables {xₖ} and {xₗ} (k≠l), E₀=H({xₖ})=H({xₗ}). The following equation (12) is obtained from equation (10).

π({xₖ})Σₘ₌₁^{M}P_{k→m}=Σₘ₌₁^{M}P_{m→k}π({xₘ})=P_{k→k}π({xₖ})+P_{l→k}π({xₗ})+Σ_{m=1,m≠k,m≠l}^{M}P_{m→k}π({xₘ}) (12)

In equation (12), P_{l→k}=1 and P_{k→l}=1 are apparent. Similarly, the following equation (13) is obtained.

π({xₗ})Σₘ₌₁^{M}P_{l→m}=Σₘ₌₁^{M}P_{m→l}π({xₘ})=P_{k→l}π({xₖ})+P_{l→l}π({xₗ})+Σ_{m=1,m≠k,m≠l}^{M}P_{m→l}π({xₘ}) (13)

The transition destinations {xₖ} and {xₗ} have the same values of energy. Therefore, the transition probabilities are the same, and the following equation (14) holds.

Σ_{m=1,m≠km≠l}^{M}P_{m→k}π({xₘ})=Σ_{m=1,m≠k,m≠l}^{M}P_{m→l}π({xₘ}) (14)

When subtracting equation (12) from equation (13), π({xₗ})Bₗ−π({xₖ})Bₖ=0 holds. Since E₀ is given to the set of two different state variables {xₖ} and {xₗ} (k≠l), Bₖ=Bₗ holds. Bₖ and Bₗ is not 0. Therefore, π({xₗ})=π({xₖ}).

This condition is a strong request. When the transition probability of equation (5) is defined only by energy difference, all states having the same values of energy are realized with the same probability. This condition is satisfied not only for energy. When the transition probability of equation (5) is defined only by difference between arbitrary physical quantities A, all microscopic states having the same physical quantities A are realized with the same probability regardless of whether the principle of detailed balance is established. However, this guarantees that probability distribution exists, but does not guarantee that probability distribution may be described analytically. Even when an exponentiation type transition probability is used, it does not follow that the probability distribution is an exponentiation type.

Considering that in a case of the Boltzmann distribution, a realization probability is defined only by the value of energy, and realization probabilities of microscopic states having the same energy are the same, this condition is a generalization including the Boltzmann distribution as a special case. This condition is satisfied not only for the Ising model as represented by equation (1), but also for a normal discrete finite state system.

Next, probability distribution in an energy space will be described.

There may be a plurality of sets of state variables {xₖ} for which the value of energy is Eⱼ, and these sets are collectively represented as {xₖ^{(j)}}. In this case, the total number M of states may be represented by the following equation (15).

M=Σⱼ₌₁^{M}^{_{E}}Mⱼ (15)

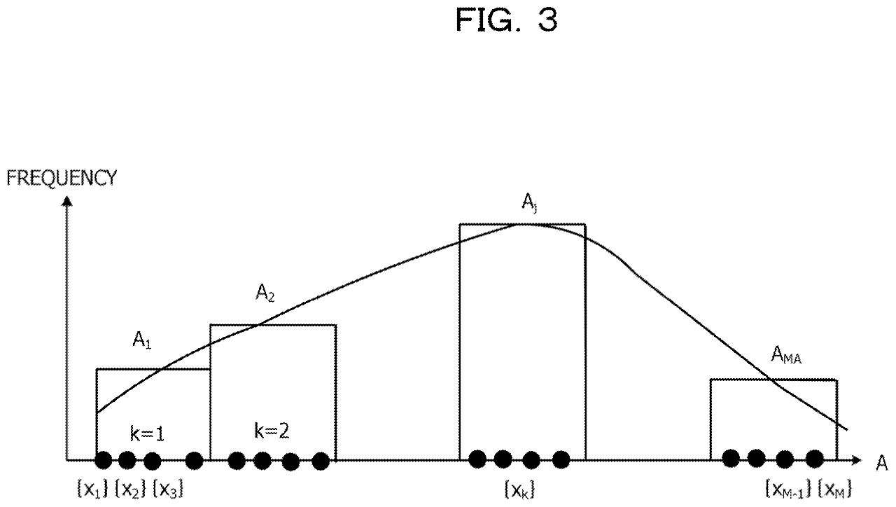

FIG. 3 is a diagram illustrating an example of a relationship between the number of states and division of energy section for physical quantity A. The horizontal axis represents A, and the vertical axis represents frequency.

There are a plurality of sets of state variables having the same physical quantity A for each value (A₁, A₂, . . . , Aⱼ, . . . A_{MA}) of physical quantity A.

Transitions to microscopic states (the sets of state variables {x₁}, {x₂}, {x₃}, and the like in FIG. 3) belonging to the same energy all have the same transition probability. From this, assuming that the k-th microscopic state ({xₖ}) belongs to Eⱼ, when the transition probability from Eⱼ to the state of E_{m′} is expressed as P_{j→m′}^{(E)}, the following equation (16) is obtained.

Σₘ₌₁^{M}P_{k→m}=Σ_{m′=1}^{M}^{_{E}}M_{m′}P_{j→m′}^{(E)} (16)

Similarly, the following equation (17) is obtained.

Σₘ₌₁^{M}P_{m→k}π({xₘ})=Σ_{m′=1}^{M}^{_{E}}M_{m′}P_{m′→j}^{(E)}π(E_{m′}) (17)

Therefore, the steady solution of the master equation is obtained by the following equation (18).

π(Eⱼ)Σ_{m′=1}^{M}^{_{E}}M_{m′}P_{j→m}^{(E)}=Σ_{m′=1}^{M}^{_{E}}M_{m′→j}^{(E)}π(E_{m′}) (18)

When probability distribution n^{(E)}(E)) that is n^{(E)}(Eⱼ)=Mⱼπ(Eⱼ) is introduced, equation (18) may be represented by the following equation (19).

$$\frac{{n}^{( E )} ( {E}_{j} )}{{M}_{j}} {\sum }_{{m}^{′} = 1}^{{M}_{E}} {M}_{{m}^{′}} {P}_{j \to {m}^{′}}^{( E )} = {\sum }_{{m}^{′} = 1}^{{M}_{E}} {M}_{{m}^{′}} {P}_{{m}^{′} \to j}^{( E )} n ( {E}_{{m}^{′}} ) \qquad ( 19 )$$

When both sides of equation (19) are multiplied by Mⱼ, the following equation (20) is obtained.

n^{(E)}(Eⱼ)Σ_{m′=1}^{M}^{_{E}}M_{m′}P_{j→m′}^{(E)}=Σ_{m′=1}^{M}^{_{E}}MⱼP_{m′→j}^{(E)}M_{m′}π(E_{m′}) (20)

The transition probability is redefined by the following equation (21).

\tilde{P}_{m′→j}^{(E)}=MⱼP_{m′→j}^{(E)} (21)

In this case, equation (20) may be represented by the following equation (22).

n^{(E)}(Eⱼ)Σ_{m′=1}^{M}^{_{E}}\tilde{P}_{j→m′}^{(E)}=Σ_{m′=1}^{M}^{_{E}}\tilde{P}_{m′→j}^{(E)}n^{(E)}(E_{m′}) (22)

Therefore, a transition probability in an energy space increases by the degeneracy of the value of energy. A realization probability also increases by the degeneracy of the value of energy. Since degeneracy is the number of states, in a case of N>>1, degeneracy may be obtained approximately by using the Wang-Landau method or the like, and a realization probability of a microscopic state may also be obtained.

Next, replica exchange in which probability distribution in the transition probability of equation (5) is invariant distribution will be described. Hereinafter, the number of replicas is N_{replica}, a state in which a system composed of all replicas is given by a state {{xᵢ}, βᵢ, Eᵢ} (i=1, 2, . . . , N_{replica}) is referred to as the state A, and a probability that the state A is realized is described as P_{A}. In this case, P_{A} may be represented by the following equation (23).

P_{A}=π({x₁}),β₁,E₁) . . . π({xᵢ},βᵢ,Eᵢ) . . . π({xⱼ},βⱼ,Eⱼ) . . . π({x_{N}_{_{replica}}},β_{N}_{_{replica}},E_{N}_{_{replica}}) (23)

Next, a state in which the values of temperature parameter are exchanged by replica exchange between the replica with replica number=i and the replica with replica number=j is referred to as the state B, and a probability that the state B is realized is described as P_{B}. In this case, P_{B} may be represented by the following equation (24).

P_{B}=π({x₁}),β₁,E₁) . . . π({xⱼ},βᵢ,Eⱼ) . . . π({xᵢ},βⱼ,Eᵢ) . . . π({x_{N}_{_{replica}}},β_{N}_{_{replica}},E_{N}_{_{replica}}) (24)

The master equation that the state A and the state B follows is the following equation (25).

$$\frac{{dP}_{B}}{dt} = {P}_{A} ( t ) {P}_{A \to B} - {P}_{B} ( t ) {P}_{B \to A} \qquad ( 25 )$$

In equation (25), P_{A→B} indicates a transition probability of transition from the state A to the state B. The steady state of the master equation of equation (25) is given by the equation of P_{A}(t)P_{A→B}−P_{B}(t)P_{B→A}=0.

Therefore, the following equation (26) is obtained.

$$\frac{{P}_{A \to B}}{{P}_{B \to A}} = \frac{{P}_{B} ( t )}{{P}_{A} ( t )} = \frac{n ( \{ {x}_{j} \} , {B}_{i} , {E}_{j} ) n ( \{ {x}_{i} \} , {B}_{j} , {E}_{i} )}{n ( \{ {x}_{i} ) , {B}_{i} , {E}_{i} ) n ( \{ {x}_{j} \} , {B}_{j} , {E}_{j} )} \qquad ( 26 )$$

Accordingly, an exchange probability Pₑₓ of replica exchange may be defined by the following equation (27).

$${P}_{ex} = min \{ 1 , \frac{n ( \{ {x}_{j} \} , {B}_{i} , {E}_{j} ) n ( \{ {x}_{i} \} , {B}_{j} , {E}_{i} )}{n ( \{ {x}_{i} \} , {B}_{i} , {E}_{i} ) n ( \{ {x}_{j} \} , {B}_{j} , {E}_{j} )} \} \qquad ( 27 )$$

The condition of equation (26) is called an invariant distribution condition. This is because replica exchange is performed under a constraint condition that preserves the function form of a probability distribution.

It is difficult to obtain an analysis form of probability distribution for defining Pₑₓ, but this problem may be solved as follows.

When equation (26) is converted into an equation of an energy space by using n^{(E)}(Eⱼ)=Mⱼπ(Eⱼ) described above, the following equation (28) is obtained.

$$\frac{{P}_{j , i}}{{P}_{i , j}} = \frac{n ( \{ {x}_{j} \} {B}_{i} , {E}_{j} ) n ( \{ {x}_{i} \} , {B}_{j} , {E}_{i} )}{n ( \{ {x}_{i} \} {B}_{i} , {E}_{i} ) n \{ {x}_{j} \} , {B}_{j} , {E}_{j} )} = \frac{\frac{n ( {B}_{i} , {E}_{j} ) n ( {B}_{j} , {E}_{i} )}{{M}_{j} {M}_{i}}}{\frac{n ( {B}_{i} , {E}_{i} ) n ( {B}_{j} , {E}_{j} )}{{M}_{i} {M}_{j}}} = \frac{n ( {B}_{i} , {E}_{j} ) n ( {B}_{j} , {E}_{i} )}{n ( {B}_{i} , {E}_{i} ) n ( {B}_{j} , {E}_{j} )} \qquad ( 28 )$$

Therefore, from the ratio of probability density obtained when an energy space is displayed, it is possible to define an exchange probability of replica exchange that makes probability distribution obtained by the transition probability of equation (5) an Invariant distribution. Accordingly, replica exchange that forces each replica to follow the probability distribution of π({xⱼ}, βⱼ, Eⱼ) is achieved. For example, in this method, detailed balance does not have to be established inside each replica, but detailed balance has to be established in replica exchange. In equation (28), when probability distribution is a Boltzmann distribution type, equation (3) is obtained.

Therefore, in replica exchange using the Boltzmann distribution, an equation happens to be very similar to that of the Metropolis method, but they are normally different. Whether detailed balance is established inside a replica and detailed balance in replica exchange theoretically have different origins.

Since the invariant distribution condition is a condition under which each replica holds the same probability distribution in replica exchange, this condition does not have to be used normally in a minimum value solution problem. Of course, if probability distribution in each replica is regarded as a material for constituting the entire distribution, it is easier to control if the probability distribution as a material is unchanged. However, in many cases, as long as it is irreducible in the entire system including all replicas, the possibility of reaching a solution is guaranteed.

Therefore, a transition probability in a replica and an exchange probability between replicas may be set separately. There are two conditions for this. The first condition is that an exchange probability between a certain replica and another replica is not 0, and the second condition is that a transition from a certain replica to the replica that is itself is not 0. If these two conditions are observed, a calculating person may define an exchange probability of replica exchange that is convenient for the calculation.

The processing unit 12 in FIG. 1 performs replica exchange in accordance with an exchange probability (P_{eX}) of the following equation (29).

$${P}_{ex} = min \{ 1 , \frac{n ( {B}_{i} , {E}_{j} ) n ( {B}_{j} , {E}_{i} )}{n ( {B}_{i} , {E}_{i} ) n ( {B}_{j} , {E}_{j} )} \} \qquad ( 29 )$$

By using Pₑₓ of equation (29), the Invariant distribution condition is satisfied.

FIG. 1 illustrates an example of a flow of processing performed by the processing unit 12 in an optimization method.

The processing unit 12 acquires problem information from the storage unit 11 (step S1). The processing unit 12 may acquire, from the storage unit 11, information on f(ΔEᵢⱼ) (transition probability) of equation (5), the number of times of calculation as an ending condition of solution processing by replica exchange, and the like.

Next, the processing unit 12 performs initialization processing (step S2). In a case where an energy function is represented by equation (1), the initialization processing Includes processing of Initializing state variables x₁ to x_{N} for each replica stored in the storage unit 11. For example, xₗ to x_{N} may all be initialized to 0 or to 1. xₗ to x_{N} may be initialized to be randomly set to 0 or 1 or may be initialized with a value supplied from the outside. The initialization processing includes processing of calculating an initial value of energy by equation (1) based on the problem information and the initial values of state variables. The initial value of energy is stored in the storage unit 11 as the current minimum value (E_{Min}).

After that, the processing unit 12 determines the values of a plurality of temperature parameters that are different from each other and used for solution processing of an optimal solution by the replica exchange method, and sets each of the values of the plurality of temperature parameters to any one of a plurality of replicas (step S3).

As described above, in a case where a transition probability based on the Boltzmann distribution is used, there is a portion where a change in energy with respect to a change in the value of temperature parameter is abrupt as illustrated in FIG. 2, and it is difficult to determine the temperature parameter to be set for each of a plurality of replicas. Therefore, as f(ΔEᵢⱼ) of equation (5), a transition probability that makes a change in the value of energy function with respect to a change in the value of temperature parameter gentler than that in a transition probability based on the Boltzmann distribution is used. This makes it easy to determine a temperature parameter. A method for determining a temperature parameter will be described later in a second embodiment.

The processing unit 12 performs solution processing by the replica exchange method (step S4).

The processing unit 12 performs update processing of repeating update of the value of any of a plurality of state variables (a certain number of times of MCMC calculation) in accordance with the above transition probability, for each of a plurality of replicas independently of each other. FIG. 1 illustrates an exponentiation type transition probability f(ΔEᵢⱼ)=1/(1+βΔE)^{m} (m>1) as an example of a transition probability that makes a change in energy with respect to a change in the value of temperature parameter gentler than that in a transition probability based on the Boltzmann distribution.

The processing unit 12 repeats processing of exchanging the values (any value) of a plurality of temperature parameters set for each of the plurality of replicas between the plurality of replicas every certain number of times in accordance with Pₑₓ of equation (29). The processing unit 12 may exchange states (the values of N state variables) instead of exchanging the values of temperature parameter.

The probability density in equation (29) (n(βᵢ, Eⱼ) or the like) is relatively easily obtained by performing independent sampling calculation for each value of temperature parameter. An example of a method for calculating a probability density and a more detailed example of solution processing by the replica exchange method will be described in the second embodiment.

For example, the processing unit 12 calculates energy each time MCMC calculation is performed in each replica, and updates E_{Min} when energy lower than the current E_{Min} stored in the storage unit 11 is obtained. The processing unit 12 outputs E_{Min} obtained at the time when a predetermined number of times of replica exchange is completed, as a calculation result, to, for example, an external device (external computer, storage medium, display device, or the like) (step S5), and ends the processing.

The processing unit 12 may store the values of x₁ to x_{N} obtained when E_{Min} is obtained in the storage unit 11, and may output the last stored values of x₁ to x_{N} together with E_{Min}.

According to the information processing apparatus 10 according to the first embodiment and the optimization method described above, MCMC calculation is performed for each replica by using a transition probability that makes a change in the value of evaluation function with respect to a change in the value of temperature parameter gentler than that in a transition probability based on the Boltzmann distribution. Accordingly, since a phase transition that occurs in a case where a transition probability based on the Boltzmann distribution is used is suppressed, it is easy to determine a temperature parameter.

In a case where a transition probability different from a transition probability based on the Boltzmann distribution is used, the invariant distribution condition is not obvious, but as described above, by performing replica exchange with an exchange probability satisfying the invariant distribution condition, probability distributions will be the same before and after the replica exchange. This increases the stability of calculation and makes it easier to control calculation. For example, an energy space may be stably sampled, and as a result, the solution efficiency is stabilized.

### Second Embodiment

In the second embodiment described below, as a transition probability that makes a change in the value of evaluation function with respect to a change in the value of temperature parameter gentler than that in a transition probability based on the Boltzmann distribution, an exponentiation type transition probability represented by the following equation (30) is used.

$$f ( Δ {E}_{ij} ) = \frac{1}{{( 1 + B Δ E )}^{m}} \qquad ( 30 )$$

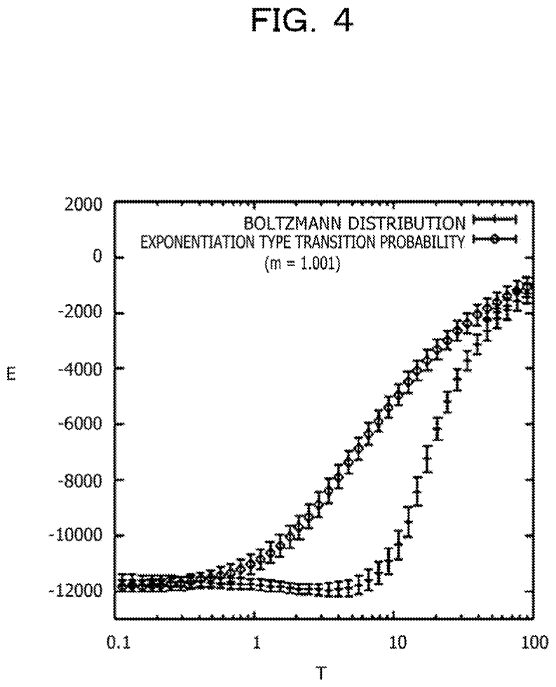

FIG. 4 is a diagram Illustrating an example of a difference in temperature dependence of energy between a case of using a transition probability based on the Boltzmann distribution and a case of using an exponentiation type transition probability. The horizontal axis represents temperature parameter T), and the vertical axis represents energy (E). The exponentiation type transition probability used is obtained by equation (30) with m=1.001.

An expected value <E> of energy may be represented by the following equation (31).

$$( E ) = \int E ( X ) P ( X ) dX = \frac{1}{{N}_{data}} {\sum }_{i = 1}^{{N}_{data}} {E}_{i} \qquad ( 31 )$$

E(X) is H({x}) of equation (1), P(X) is probability distribution of a certain state X, and N_{data} is the number of pieces of data acquired by sampling.

FIG. 4 is obtained by starting sampling after an equilibrium state is reached for each value of temperature parameter, and acquiring Eᵢ of N_{data} having a sufficiently large value.

As Illustrated in FIG. 4, in the low temperature region and in the limit of high temperature, the temperature dependence of energy in the case of using a transition probability based on the Boltzmann distribution and the temperature dependence of energy in the case of using an exponentiation type transition probability are approximately equal to each other. However, a remarkable difference appears in the intermediate temperature region. In the case of using a transition probability based on the Boltzmann distribution, energy abruptly changes in the vicinity of the value of temperature parameter corresponding to a phase transition. The change becomes abrupt and may look like the case of the lambda point as the degree of freedom increases. On the other hand, in the case of using an exponentiation type transition probability, the increase in energy is gentler than in the case of using a transition probability based on the Boltzmann distribution.

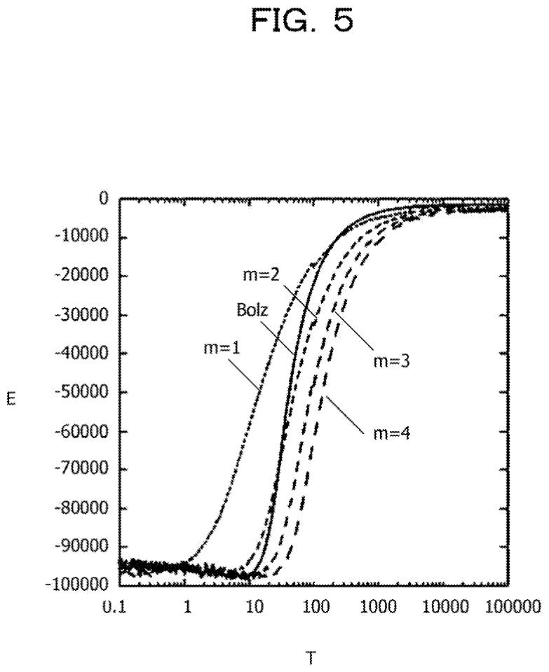

FIG. 5 is a diagram Illustrating an example of a relationship between an exponent of an exponentiation type transition probability and temperature dependence of energy (expected value). The horizontal axis represents temperature parameter (T), and the vertical axis represents energy (E). For comparison, the temperature dependence of energy in the case of using a transition probability based on the Boltzmann distribution (denoted as “Bolz”) is also illustrated.

As the exponent (m) of an exponentiation type transition probability Increases, the Increase rate of energy with respect to temperature gradually increases. For example, as m increases, a phase transition-like phenomenon appears more markedly. Therefore, for example, in a case of m>4, the interval for temperature parameters at the time of replica exchange is selected more carefully. In order to make it easier to determine the value of temperature parameter, for example, it is desirable that 1<m≤4.

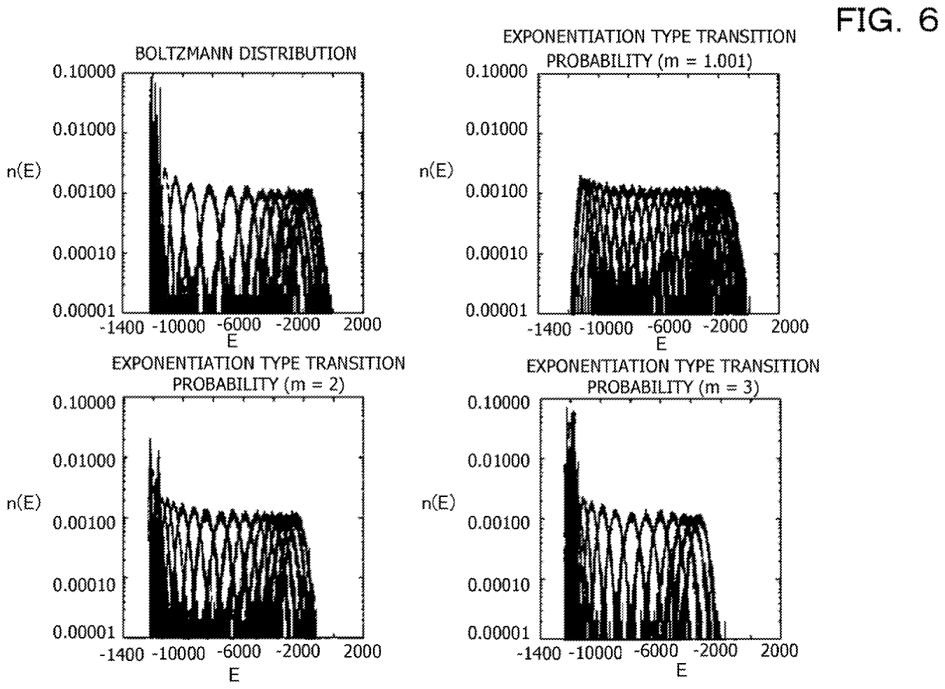

FIG. 6 is a diagram Illustrating probability density distribution in an energy space obtained in a replica for which each value of temperature parameter is set. The horizontal axis represents energy (E), and the vertical axis represents probability density n(E).

Replica exchange is not performed, and the value of temperature parameter of each replica is fixed. The same temperature column (same temperature parameter group) is used in the calculation of all four cases in FIG. 6. In the calculation example of FIG. 6, temperature parameter (Tₘᵢₙ) Indicating the minimum temperature is Tₘᵢₙ=1.0, temperature parameter (Tₘₐₓ) indicating the maximum temperature is Tₘₐₓ₌100, and the number of replicas is 26.

FIG. 6 illustrates examples of four cases of probability density distribution in an energy space, for example, probability density distribution obtained when a transition probability based on the Boltzmann distribution is used, probability density distribution obtained when an exponentiation type transition probability with m=1.001 is used, probability density distribution obtained when an exponentiation type transition probability with m=2 is used, and probability density distribution obtained when an exponentiation type transition probability with m=3 is used.

As Illustrated in FIG. 6, in an intermediate energy state in the vicinity of a phase transition point (a region of E=about −4000 to −10000), the interval between vertices of probability density distribution tends to be larger when a transition probability based on the Boltzmann distribution is used than when an exponentiation type transition probability is used. This corresponds to an abrupt change in energy as a function of temperature parameter.

The interval between vertices of energy in the intermediate energy state tends to be smaller when an exponentiation type transition probability is used than when a transition probability based on the Boltzmann distribution is used. Therefore, sampling in the intermediate energy state is easier when an exponentiation type transition probability is used than when a transition probability based on the Boltzmann distribution is used.

As the exponent m of an exponentiation type transition probability increases, intervals between vertices of probability density distribution in the Intermediate energy state tend to be larger.

For example, an interval between vertices of probability density distribution obtained in two replicas in which the values of adjacent temperature parameters are set is insensitive to the value of temperature parameter. Therefore, as m decreases, it is easier to set temperature parameters.

However, probability distribution created by a transition probability based on the Boltzmann distribution is fundamentally different from probability distribution created by an exponentiation type transition probability. Therefore, the influence thereof appears in the low temperature region. In the case of the calculation example in FIG. 6, it may be seen that the sampling performance deteriorates in the low temperature region with an exponentiation type transition probability, since temperature parameters are determined to make it easier to sample when using a transition probability based on the Boltzmann distribution. This is because a region considered to be sufficiently low temperature when the transition probability based on the Boltzmann distribution is used is not sufficiently low temperature when an exponentiation type transition probability is used. This problem may be solved by setting the temperature parameter (Tₘᵢₙ) indicating the minimum temperature to be smaller than that set when a transition probability based on the Boltzmann distribution is used.

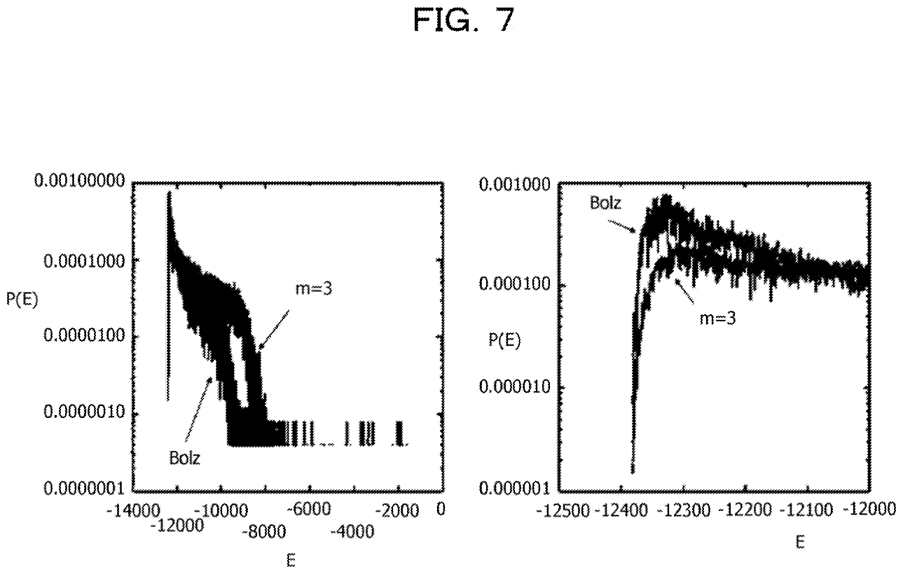

FIG. 7 is a diagram Illustrating probability density distribution in an energy space obtained when replica exchange is performed. In the calculation example of FIG. 7, the same temperature parameter setting conditions as those in the calculation of FIG. 6 are used. The left diagram of FIG. 7 illustrates a probability distribution function numerically calculated for the entire energy region in which sampling is performed. The right diagram of FIG. 7 is an enlarged view of the left diagram of FIG. 7 for E=−12500 to −12000. The horizontal axis represents energy (E), and the vertical axis represents probability density (P(E)). The exponentiation type transition probability used is obtained by equation (30) with m=3. For comparison, the probability density distribution in the case of using a transition probability based on the Boltzmann distribution (denoted as “Bolz”) is also illustrated.

As illustrated in the right diagram of FIG. 7, on the low energy side, the probability density is larger when a transition probability based on the Boltzmann distribution is used than when an exponentiation type transition probability is used. On the other hand, as illustrated in the left diagram of FIG. 7, on the high energy side, the probability density is larger when an exponentiation type transition probability is used. As a whole, the behavior of probability density in an energy space is flatter when an exponentiation type transition probability is used than when a transition probability based on the Boltzmann distribution is used. However, this is not as flat as the flatness in the case of the multicanonical method in which such a flat histogram is created that the entire energy region in an energy space is visited numerically and Intentionally with an equal probability.

This characteristic indicates that there is an aspect that is advantageous when searching for a ground state. This is because it is considered that efficient forgetting of a memory leads to an efficient search. The forgetting of a memory described here means not being affected by the structure of a specific energy landscape by transition to a high temperature state. An advantage of the replica exchange method is that a state may efficiently escape from a deep energy local minimum structure by transition to a high temperature side. However, when the degree of freedom of a system Increases, energy abruptly changes in the vicinity of a phase transition point, and it is difficult to make an efficient transition to a high temperature region. Conversely, an efficient transition to a high temperature region leads to sampling of a wider solution space.

From the results described so far, it may be seen that the number of replicas may be reduced when using an exponentiation type transition probability.

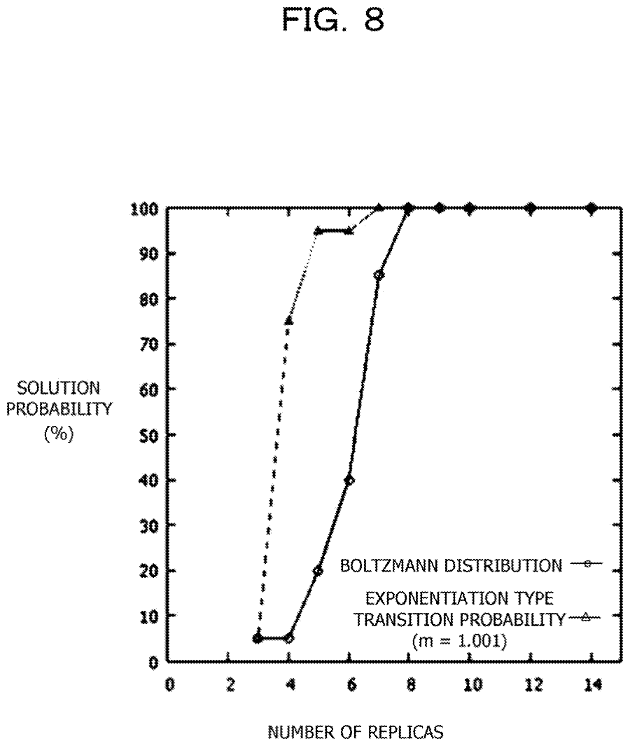

FIG. 8 is a diagram Illustrating a calculation example of the maximum cut problem by the replica exchange method. The adopted problem is a problem called G43 whose optimal solution is known. The horizontal axis represents the number of replicas, and the vertical axis represents solution probability (%). The exponentiation type transition probability used is obtained by equation (30) with m=1.001. For comparison, a calculation example in the case of using a transition probability based on the Boltzmann distribution is also Illustrated.

In FIG. 8, calculation is performed 100,000 times for each replica, and the replica exchange frequency is once every 10 times. After the calculation is completed, the number of replicas reaching a solution of the ground state (optimal solution) is counted, and a solution probability is calculated therefrom. For example, in a case where calculation is performed by using 26 replicas, the solution probability is 100% when all of the 26 replicas reach the optimal solution.

As may be seen from FIG. 7, as the number of replicas decreases, the solution probability lowers. However, when an exponentiation type transition probability is used, an optimal solution is obtained even with a smaller number of replicas than when a transition probability based on the Boltzmann distribution is used.

As described above, this is an effect due to the fact that the temperature dependence of energy is less sensitive to the value of temperature parameter by using an exponentiation type transition probability than in the case of using a transition probability based on the Boltzmann distribution. For example, since the Interval for the value of temperature parameter does not have to be small, the number of replicas may be reduced accordingly.

This phenomenon will be described below using equations. It is assumed that replica exchange is Ideally performed, and ρ(E) as probability distribution in which an energy space is evenly visited, is obtained. ρ(E) is probability distribution obtained by all replicas. In this case, when ρ(E) is expressed as the sum of ρₛ, which is the Boltzmann distribution, it may be represented by the following equation (32).

ρ(F)=Σᵢ₌₁ρ_{B}(Tᵢ,E) (32)

Similarly, when ρ(E) is expressed as the sum of ρ_{P}, which is probability distribution obtained by the transition probability of equation (5), it may be represented by the following equation (33).

ρ(E)=Σᵢ₌₁ρ_{P}(Tᵢ,E) (33)

For example, it comes down to a problem in which two different distribution functions constitute ρ(E) for efficient calculation. In this case, when a transition probability based on the Boltzmann distribution is used, as may be seen from FIG. 5, energy abruptly changes in the vicinity of a phase transition point. Therefore, in equation (32), in order to sample all energy regions equally, a large number of temperature parameters have to be taken in the vicinity of a phase transition point. Therefore, the number of terms of the sum constituting equation (32) increases.

On the other hand, in an exponentiation type transition probability, as may be seen from FIG. 5, a phase transition point corresponding to a phase transition does not clearly appear, and it is possible to create desirable overall probability distribution from equation (33) without taking a large number of temperature parameters.

Next, a condition for minimizing the number of replicas will be described. This is a condition that does not have to be satisfied in minimum value solution, but has to be satisfied in order to minimize the number of replicas. The condition is that the probability density distribution in the energy space created by the replica with replica number=i overlaps only with the probability density distribution created by the replica with replica number=i−1 and the probability density distribution created by the replica with replica number i+1.

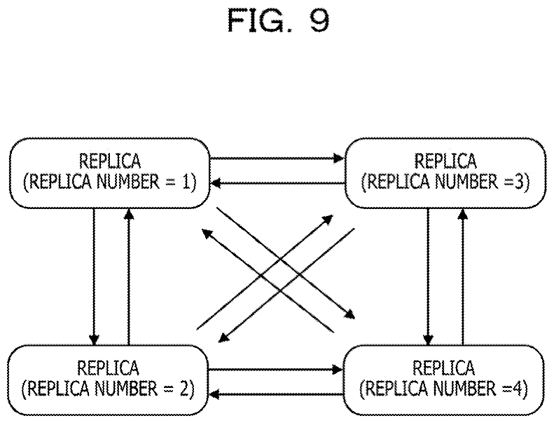

FIG. 9 is a schematic diagram illustrating an example of detailed balance in the replica exchange method.

FIG. 9 illustrates a detailed balance state for four replicas with replica numbers=1 to 4. Among the four replicas, replica exchange is possible between any two replicas.

In the replica exchange method, the principle of detailed balance is applied to any two replicas to be exchanged. This is requested from equation (26). The principle of detailed balance is requested for all of any two replicas. Therefore, N_{replica} (N_{replica}−1)/2 combinations are normally generated when replica exchange is performed once. However, by appropriately setting temperature parameters, replica exchange is performed only between adjacent temperature parameters.

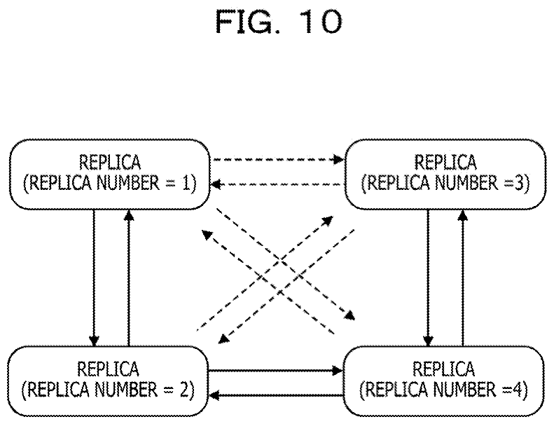

FIG. 10 is a diagram illustrating an example of replica exchange only between adjacent temperature parameters.

In FIG. 10, it is assumed that the smallest temperature parameter is set for the replica with replica number=1, the next smallest temperature parameter is set for the replica with replica number=2, the second largest temperature parameter is set for the replica with replica number=3, and the largest temperature parameter is set for the replica with replica number=4.

For example, when the probability density distribution created by the replica with replica number=2 overlaps only with the probability density distribution created by the replica with replica number=1 and the probability density distribution created by the replica with replica number=3, trial of exchange between the replica with replica number=2 and the replica with replica number=4 is rejected without fall. It may be seen that, by selecting values of a plurality of temperature parameters in this manner, only trial of exchange between replicas for which adjacent temperature parameters are set has to be performed. Strictly, the overlap of probability density distribution between the replica with replica number=2 and the replica with replica number=4 is not zero. However, every calculation is performed with a finite number of digits, and when temperature parameters are appropriately set, a situation may be created in which the exchange probability may be treated as 0.

On the other hand, there are two types of implementation that are often employed in the replica exchange method.

The first one is implementation called adjacent exchange. It is assumed as a condition in this implementation that only the probability density distribution of replicas for which adjacent temperature parameters are set overlap each other. This implementation is simple and this condition is often used, but regarding the setting of temperature parameters, a calculating person has to determine the value of temperature parameter in advance by preliminary calculation or the like so as to observe the above condition.

The second one is a method called random exchange. This is a method in which any two replicas are selected by using a random number, and all replicas are set as exchange targets. In this method, if a long-time average is taken, trial of exchange between any two replicas is performed. Therefore, this method is characterized in that, even in a case where the probability density distribution of a certain replica in an energy space overlaps, to a degree that is not negligible, with the probability density distribution of a replica for which a temperature parameter other than the adjacent temperature parameter is set, the condition of detailed balance is satisfied. Even when either method is employed, if the object is limited to minimum value solution, Irreducibility is guaranteed, and therefore, in principle, it is not Impossible to reach a solution.

However, in consideration of efficiency, when the condition of detailed balance between replicas is not satisfied, the invariant distribution condition is not satisfied. Therefore, it may be disadvantageous to control the probability density distribution in an energy space created by the entire replica system. Since the object in this case is to reduce the number of replicas used for replica exchange, in order to suppress the number of replicas to the minimum, a temperature parameter is determined such that the invariant distribution condition is observed in replica exchange between replicas in which adjacent temperature parameters are set.

In this manner, the minimum number of replicas and the values of a plurality of temperature parameters may be determined. A more specific determination method will be described below.

First, the number of replicas is set to be relatively large, and probability density distribution in an energy space is obtained without replica exchange as Illustrated in FIG. 6. The value of energy that gives a vertex of probability density distribution for each value of temperature parameter and a spread (standard deviation) of the probability density distribution are obtained. From these, energy that gives a vertex of probability density distribution may be obtained as a function of temperature parameter. On the other hand, the degree of overlapping may be obtained from the spread of probability density distribution. From the energy that gives a vertex and the degree of overlapping, while considering the magnitude of exchange probability, it is possible to select such a plurality of temperature parameters that only values of adjacent temperature parameters are exchanged.

By using the fact that the distribution of energy (expected value) obtained in the case of using an exponentiation type transition probability is close to normal distribution in the high temperature regions as illustrated in FIG. 5, for example, a temperature parameter A may be selected so as to satisfy the following equation (34).

E_{ave,i}^{β}^{ᵢ}+nσ_{ave,i}^{β}^{ᵢ}=E_{ave,i}^{β}^{ᵢ₊₁}−nσ_{ave,i+1}^{β}^{ᵢ₊₁} (34)

In equation (34), the first term on the left side is energy that gives a vertex of probability density distribution in an energy space by the replica with replica number=i, and the second term on the left side is a value obtained by multiplying a standard deviation of the probability density distribution by a predetermined coefficient n. The first term on the right side is energy that gives a vertex of probability density distribution by the replica with replica number=i+1, and the second term on the right side is a value obtained by multiplying a standard deviation of the probability density distribution by n.

n is a variable Indicating the degree of overlapping of probability density distribution. When increasing an exchange probability, the number of replicas increases since the degree of overlapping has to be increased. When an exchange probability may be reduced, the number of replicas may be reduced.

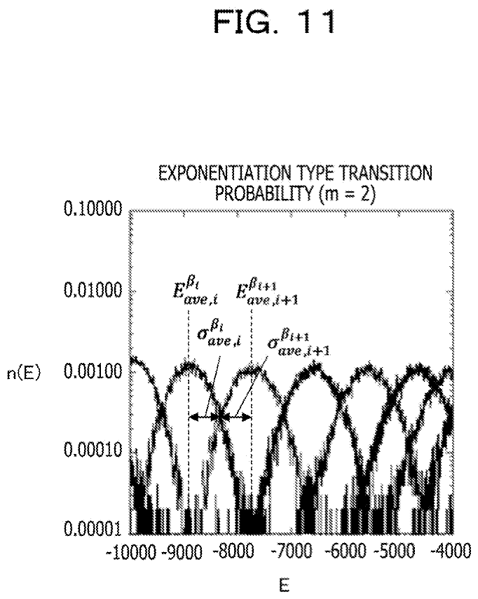

FIG. 11 is a diagram illustrating an example of energy that gives a vertex of probability density distribution in an energy space and a standard deviation of the probability density distribution. The horizontal axis represents energy (E), and the vertical axis represents probability density n(E). FIG. 11 illustrates a part of the probability density distribution obtained by using an exponentiation type transition probability with m=2 in FIG. 6.

FIG. 11 illustrates an example of energy that gives a vertex of probability density distribution in an energy space by the replica with replica number=i, which is the first term on the left side of equation (34), and an example of a standard deviation of the probability density distribution. FIG. 11 illustrates an example of energy that gives a vertex of probability density distribution by the replica with replica number=i+1, which is the first term on the right side, and an example of a standard deviation of the probability density distribution.

In the calculation temperature parameter T, T is determined in ascending order.

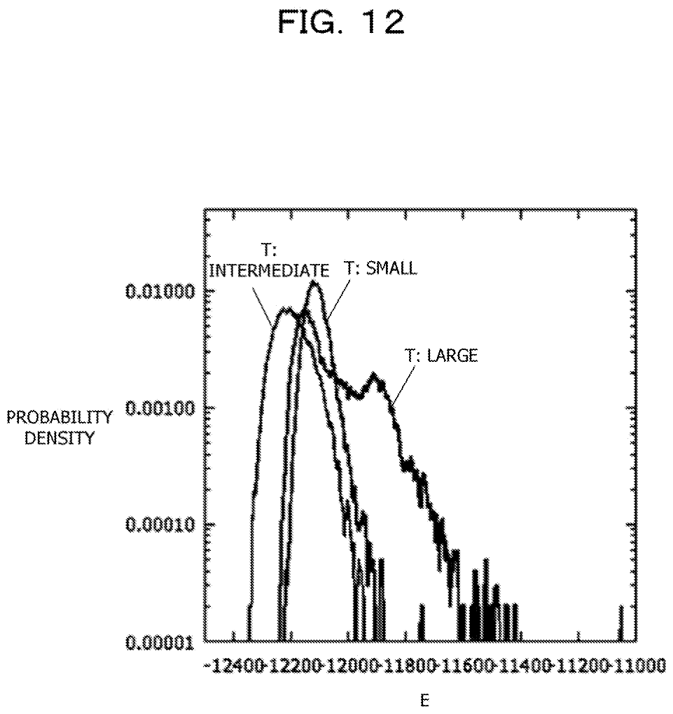

FIG. 12 is a diagram illustrating an example of behavior of probability density distribution in a low temperature region. The horizontal axis represents energy, and the vertical axis represents probability density.

FIG. 12 illustrates probability density distribution in an energy space in a low temperature region. When the value of temperature parameter is too small in the low temperature region (see “T: small” in FIG. 12), transition itself does not occur. Therefore, search efficiency on the low energy side decreases. On the other hand, when the value of temperature parameter is large (see “T: large” in FIG. 12), transition is made too much, and search efficiency on the low temperature side decreases. Therefore, there is an optimal value (for example, “T: medium” in FIG. 12) when selecting the smallest value of temperature parameter. As illustrated in FIG. 5, this optimal value may be determined by that, when energy is calculated as a function of temperature parameter, an expected value of energy takes a minimum value at a certain value of temperature parameter.

The minimum value of temperature parameter is affected by an artifact caused by reducing the number of times of trial of preliminary calculation. However, since it is difficult to perform a sufficiently large number of times of trial even in the calculation after optimizing the value of temperature parameter, the value of temperature parameter that gives the pseudo minimum value is taken as the minimum value.

After the minimum value of temperature parameter is determined, the remaining values of temperature parameter may be determined in accordance with equation (34). In this case, an energy function as a function of temperature parameter is obtained by using an interpolation method or the like. Similarly, a standard deviation is obtained by using an interpolation method or the like. Any interpolation method may be used. However, since an error increases in the low temperature region, a smoothed curve is to be obtained by using curve interpolation using a least squares method or the like. After an interpolation curve is obtained, energy at a vertex of probability density distribution by the replica with replica number=i+1 and a standard deviation of the probability density distribution that satisfy equation (34) may be obtained. Corresponding βᵢ₊₁, for example, Tᵢ₊₁ may be obtained therefrom.

(Example of Hardware Configuration)

The replica exchange method and the method for determining a temperature parameter as described above may be realized by the following hardware, for example.

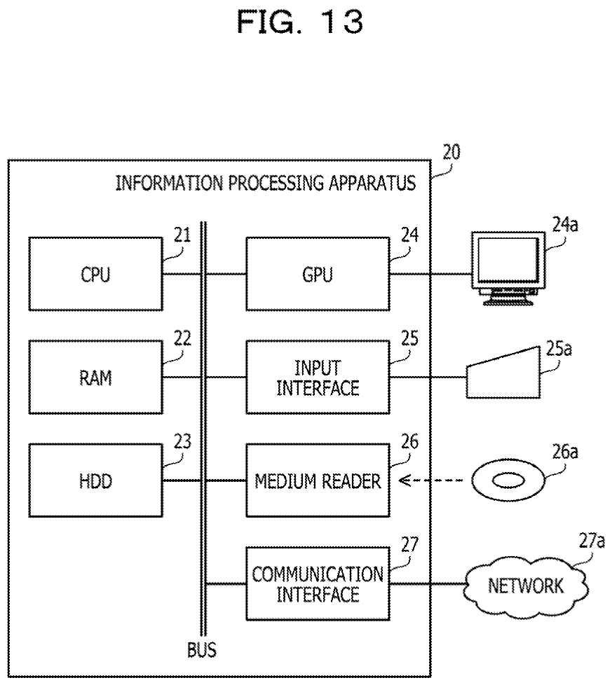

FIG. 13 is a diagram illustrating a hardware example of an information processing apparatus according to the second embodiment.

An information processing apparatus 20 according to the second embodiment is, for example, a computer and includes a CPU 21, a RAM 22, an HDD 23, a graphics processing unit (GPU) 24, an input interface 25, a medium reader 26, and a communication interface 27. The above-described units are coupled to a bus.

The CPU 21 is a processor Including an arithmetic circuit that executes program commands. The CPU 21 loads at least part of a program and data stored in the HDD 23 into the RAM 22 and executes the program. The CPU 21 may include a plurality of processor cores, the information processing apparatus 20 may include a plurality of processors, and the processing to be described below may be executed in parallel by using a plurality of processors or processor cores. A set of a plurality of processors (multiprocessor) may be referred to as a “processor”.

The RAM 22 is a volatile semiconductor memory that temporarily stores a program executed by the CPU 21 and data used for computation by the CPU 21. The information processing apparatus 20 may include a type of memory other than the RAM, and may include a plurality of memories.

The HDD 23 is a non-volatile storage device that stores data as well as programs of software such as an operating system (OS), middleware, and application software. The program Includes, for example, an optimization program for executing an optimization method by the replica exchange method. The information processing apparatus 20 may include other types of storage devices such as a flash memory and a solid-state drive (SSD), and may include a plurality of non-volatile storage devices.

The GPU 24 outputs an image to a display 24a coupled to the information processing apparatus 20 in accordance with a command from the CPU 21. As the display 24a, a cathode ray tube (CRT) display, a liquid crystal display (LCD), a plasma display panel (PDP), an organic electro-luminescence (OEL) display, or the like may be used.

The input interface 25 acquires an input signal from an input device 25a coupled to the information processing apparatus 20 and outputs the input signal to the CPU 21. As the input device 25a, a pointing device such as a mouse, a touch panel, a touchpad, and a trackball, a keyboard, a remote controller, a button switch, or the like may be used. A plurality of types of input devices may be coupled to the information processing apparatus 20.

The medium reader 26 is a reading device that reads programs and data recorded on a recording medium 26a. As the recording medium 26a, for example, a magnetic disk, an optical disk, a magneto-optical (MO) disk, a semiconductor memory, or the like may be used. The magnetic disk includes a flexible disk (FD) and an HDD. The optical disk includes a compact disc (CD) or a Digital Versatile Disc (DVD).

For example, the medium reader 26 copies a program or data read from the recording medium 26a to another recording medium such as the RAM 22 and the HDD 23. For example, the read program is executed by the CPU 21. The recording medium 26a may be a portable recording medium, and may be used to distribute programs and data. The recording medium 26a and the HDD 23 may be referred to as a computer-readable recording medium.

The communication interface 27 is an interface that is coupled to a network 27a and that communicates with another information processing apparatus via the network 27a. The communication Interface 27 may be a wired communication interface coupled to a communication device such as a switch via a cable, or may be a wireless communication interface coupled to a base station via a wireless link.

Next, functions and processing procedures of the information processing apparatus 20 will be described.

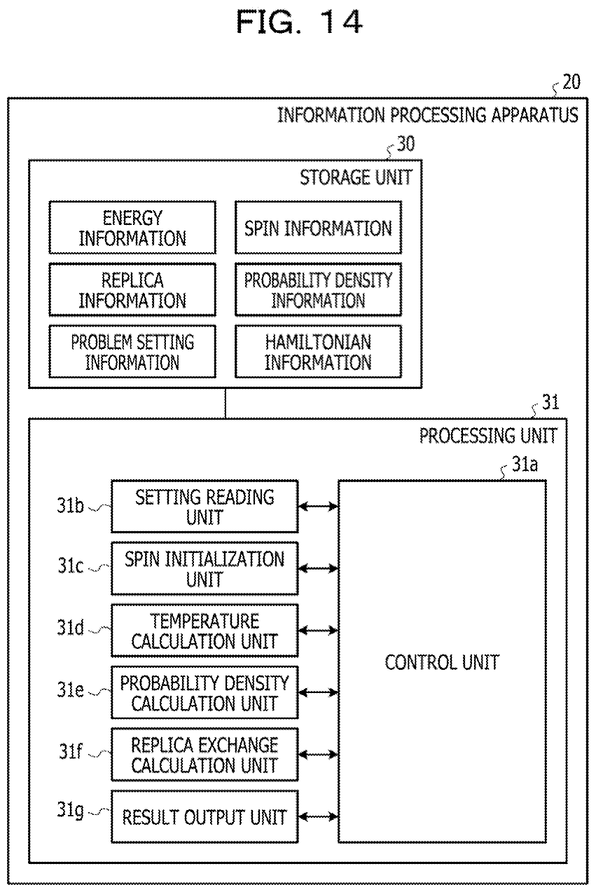

FIG. 14 is a block diagram illustrating a function example of the information processing apparatus according to the second embodiment.

The information processing apparatus 20 includes a storage unit 30 and a processing unit 31. The processing unit 31 includes a control unit 31a, a setting reading unit 31b, a spin initialization unit 31c, a temperature calculation unit 31d, a probability density calculation unit 31e, a replica exchange calculation unit 31f, and a result output unit 31g.

For example, the storage unit 30 may be implemented by using a storage area secured in the HDD 23. For example, the processing unit 31 may be Implemented by using a program module executed by the CPU 21.

The storage unit 30 stores energy Information, spin information, replica information, probability density information, problem setting information, and Hamiltonian information.

The energy information includes an initial value of calculated energy and a minimum value of energy calculated so far. The energy information may include the value of each state variable corresponding to the minimum value of energy. The spin information includes the value of each state variable. The replica information is information used to execute the replica exchange method, and includes the number of replicas (N_{replica}), a replica exchange frequency (Nₑₓ), a value of temperature parameter representing the minimum temperature (Tₘᵢₙ), and a value of temperature parameter representing the maximum temperature (Tₘₐₓ). The probability density information includes information on probability density (n(βᵢ, Eⱼ) or the like) for calculating the exchange probability of equation (28). The probability density information further includes, for example, the number of bins in a histogram (N_{bin}) and the frequency of updating probability density (N_{prob}) in a case of evaluating probability density distribution by a histogram as described later. The problem setting information includes information on a transition probability to be used (the value of the exponent (m) of the above-described exponentiation type transition probability), the number of times of calculation for preliminary calculation (Nₚᵣₑ), the number of times of calculation for obtaining an optimal solution after preliminary calculation (Nᵢₜₑᵣ), and information on the spin Initialization method (method for determining an initial value of a state variable). The Hamiltonian information includes, for example, the weight coefficient (Wᵢⱼ), the bias coefficient (bᵢ), and the constant (C) of the energy function of equation (1), and is an example of the problem information described above.

The control unit 31a controls each unit of the processing unit 31.

The setting reading unit 31b reads the various pieces of information from the storage unit 30 in the form understandable by the control unit 31a.

The spin initialization unit 31c performs initialization of spins (state variables).

The temperature calculation unit 31d determines a temperature parameter set for each replica.

The probability density calculation unit 31e calculates probability density (n(βᵢ, Eⱼ) or the like) for calculating the exchange probability of equation (28).

The replica exchange calculation unit 31f executes solution processing by the replica exchange method (hereinafter referred to as replica exchange processing).

The result output unit 31g outputs a result of replica exchange processing (search result). For example, when replica exchange processing satisfies a predetermined ending condition, the result output unit 31g outputs, as a search result, the minimum energy obtained up to that time and the value of each state variable that gives the minimum energy.

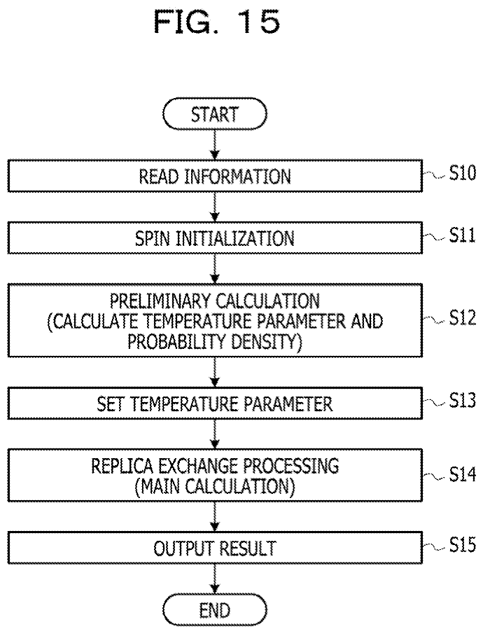

FIG. 15 is a flowchart illustrating an example of a flow of processing by the information processing apparatus according to the second embodiment.

When processing is started, first, the setting reading unit 31b reads the various pieces of information from the storage unit 30 in the form understandable by the control unit 31a (step S10). After that, the spin initialization unit 31c performs initialization of state variables (step S11). Preliminary calculation is performed by the temperature calculation unit 31d and the probability density calculation unit 31e (step S12). In the processing of step S12, a temperature parameter is calculated by the temperature calculation unit 31d, and probability density used for calculation of an exchange probability is calculated by the probability density calculation unit 31e. Information on the calculated probability density is stored in the storage unit 30.

After that, the control unit 31a sets temperature parameter values different from each other in a plurality of replicas, respectively (step S13).

The replica exchange calculation unit 31f performs replica exchange processing (step S14), and a result of the processing is output (step S15). For example, when replica exchange processing satisfies a predetermined ending condition (for example, that the number of times of calculation has reached Nᵢₜₑᵣ), the result output unit 31g outputs, as a result of the replica exchange processing, the minimum energy obtained up to that time and the value of each state variable that gives the minimum energy.

After that, the processing of the information processing apparatus ends. Hereinafter, the processing of step S14 may be referred to as main calculation in comparison with the preliminary calculation of step S12.

(Example of Information Reading Processing)

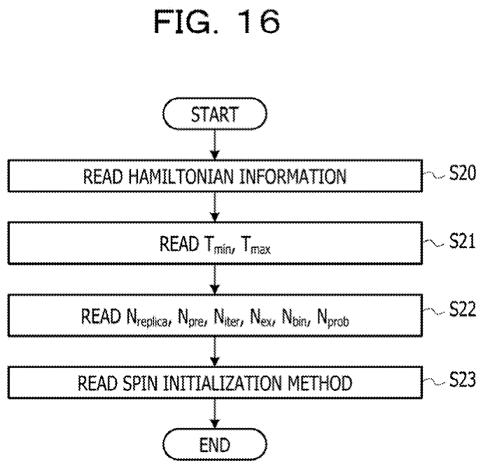

FIG. 16 is a flowchart illustrating an example of a flow of information reading processing.

The setting reading unit 31b reads the Hamiltonian information (the weight coefficient (Wᵢⱼ), the bias coefficient (bᵢ), and the constant (C) of the energy function of equation (1)) from the storage unit 30 (step S20).

The setting reading unit 31b reads Tₘᵢₙ and Tₘₐₓ from the storage unit 30 (step S21).

The setting reading unit 31b reads N_{replica}, Nₚᵣₑ, Nᵢₜₑᵣ, Nₑₓ, N_{bin}, and N_{prob} from the storage unit 30 (step S22).

The setting reading unit 31b reads the spin initialization method from the storage unit 30 (step S23), and ends the information reading processing.

The flow of processing illustrated in FIG. 16 is an example, and the order of the processing may be changed as appropriate.

(Example of Spin Initialization Processing)

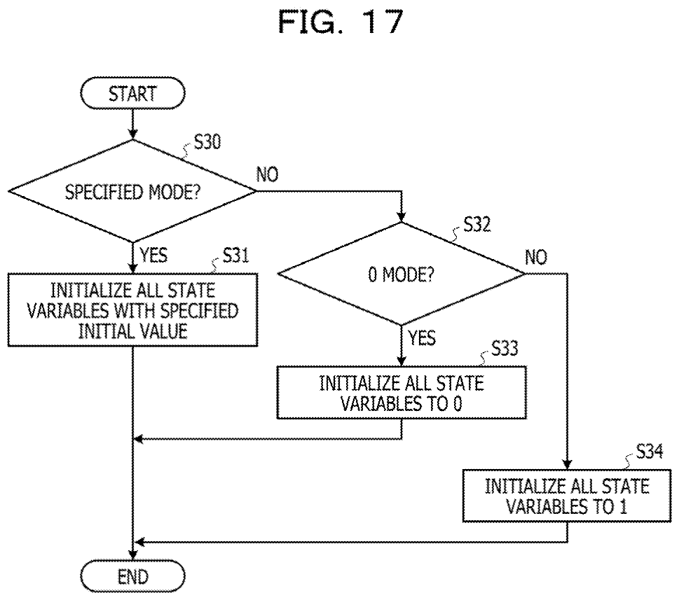

FIG. 17 is a flowchart illustrating an example of a flow of spin initialization processing.

The spin initialization unit 31c determines whether the spin initialization method is the specified mode (step S30). When it is determined that the spin Initialization method is the specified mode, the spin initialization unit 31c Initializes all state variables with the Initial value of each state variable specified from the outside of the information processing apparatus 20 (step S31), and ends the spin initialization processing.

When it is determined that the spin initialization method is not the specified mode, the spin initialization unit 31c determines whether the spin Initialization method is the 0 mode (step S32). When it is determined that the spin initialization method is the 0 mode, the spin initialization unit 31c initializes all state variables to 0 (step S33), and ends the spin initialization processing. When it is determined that the spin initialization method is not the 0 mode, the spin initialization unit 31c initializes all state variables to 1 (step S34), and ends the spin initialization processing.

The flow of processing illustrated in FIG. 17 is an example, and the order of the processing may be changed as appropriate.

(Example of Temperature Parameter Calculation Processing)

Next, an example of temperature parameter calculation processing, which is the first processing of the preliminary calculation in FIG. 15, will be described.

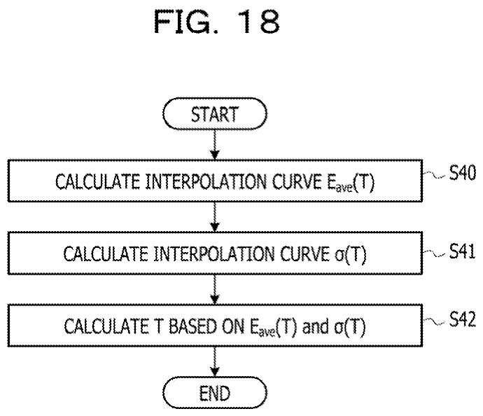

FIG. 18 is a flowchart illustrating an example of a flow of temperature parameter calculation processing.

The temperature calculation unit 31d calculates an interpolation curve of energy (Eₐᵥₑ(T)) that is a function of T from the energies at the vertices of the probability density distribution in an energy space obtained for each of the values of a plurality of temperature parameters (T) (step S40). The energies at the vertices of the probability density distribution in an energy space obtained for each of the values of a plurality of temperature parameters (T) are obtained, for example, from the result of sampling of the temperature dependence of energy using an exponentiation type transition probability illustrated in FIG. 4.

The temperature calculation unit 31d calculates an interpolation curve of standard deviation (σ(T)) that is a function of T from the standard deviation of the probability density distribution in an energy space obtained for each of the values of a plurality of temperature parameters (T) (step S41). The standard deviation of the probability density distribution in an energy space obtained for each of the values of a plurality of temperature parameters (T) is obtained, for example, from the result of sampling of the temperature dependence of energy using an exponentiation type transition probability Illustrated in FIG. 4.

Based on Eₐᵥₑ(T) and σ(T), the temperature calculation unit 31d determines N values of temperature parameters (T) from Tₘᵢₙ to Tₘₐₓ by using, for example, the bisection method so as to satisfy the relationship of equation (34) (step S42). After that, the temperature calculation unit 31d ends the temperature parameter calculation processing.

The processing order of steps S40 and S41 may be reversed.

In a case of taking less time and effort to perform temperature parameter calculation processing, the condition of adjacent exchange described above does not have to be strictly observed. This is because only the existence of an equilibrium state and irreducibility have to be guaranteed in a minimum value solution problem. It is desirable to strictly observe this condition in a case where it is desirable to calculate some physical quantity by statistical mechanical simulation, to strictly observe the condition of detailed balance, and to create a specific ensemble.

(Example of Probability Density Calculation Processing)

Next, an example of probability density calculation processing, which is the second processing of the preliminary calculation in FIG. 15, will be described.

Probability density (n(βᵢ, Eⱼ) or the like) is calculated for calculating the exchange probability (Pₑₓ) of replica exchange of equation (29). Probability density may be easily calculated by performing independent sampling calculation for each value of temperature parameter when MCMC calculation using an exponentiation type transition probability using each value of temperature parameter is performed. For example, approximation calculation using a histogram is a simple method for obtaining probability density. When preliminary calculation taking a relatively short time is performed for each of all values of temperature parameter, minimum value of energy (Eₘᵢₙ) and maximum value of energy (Eₘₐₓ) without replica exchange may be obtained. When the number of bins in a histogram is N_{bin}, there are N_{bin+1} points. In this case, when the bins have the same width, the i-th point may be represented by the following equation (35).

$${E}_{bin , i} = {E}_{min} + i \frac{{E}_{max} \cdot {E}_{min}}{{N}_{bin}} \qquad ( 35 )$$

In equation (35), i=0, 1, 2, . . . , N_{bin}. When Eₘᵢₙ=E_{bin, 0} and Eₘₐₓ=E_{bin, N}, a section [E_{bin, i}, E_{bin, i+1}] may be determined.

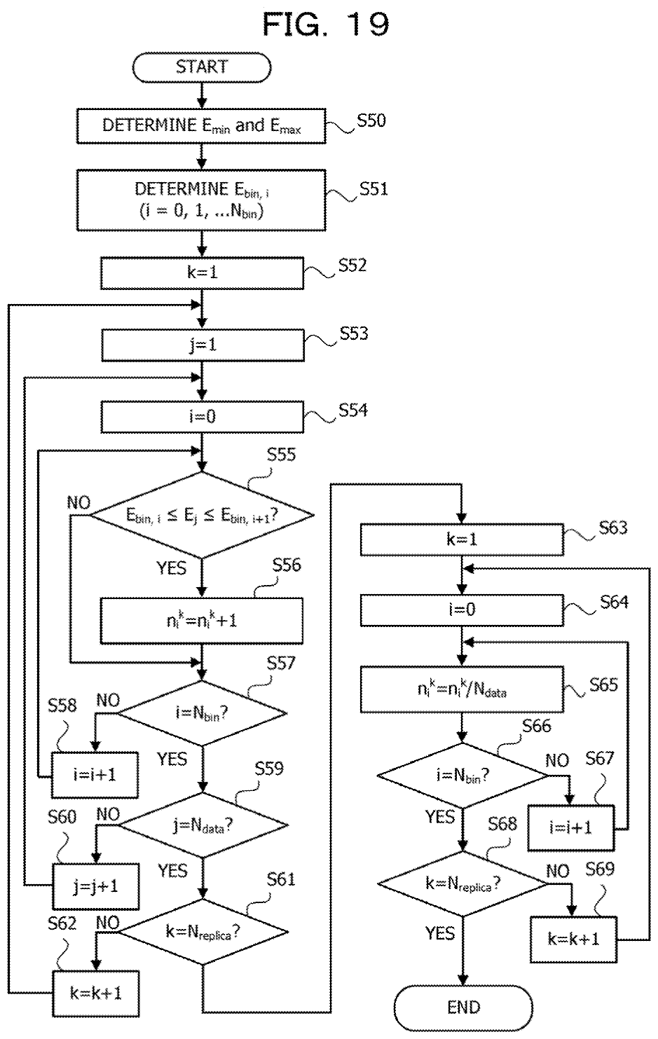

FIG. 19 is a flowchart illustrating an example of a flow of probability density calculation processing.

The probability density calculation unit 31e determines Eₘᵢₙ and Eₘₐₓ for each value of temperature parameter by the above method (step S50), and determines E_{bin, i} by equation (35) (step S51).

The probability density calculation unit 31e sets the variable k to 1 (step S52), sets the variable j to 1 (step S53), and sets the variable i to 0 (step S54).

After that, the probability density calculation unit 31e determines whether E_{bin, i}≤Eⱼ≤E_{bin, i+1} is satisfied (step S55). Eⱼ is the j-th piece of data among N_{data} pieces of data (value of energy) obtained by the sampling calculation for the value of temperature parameter set for the replica with replica number=k.

When it is determined that E_{bin, i}≤Eⱼ≤E_{bin, i+1} is satisfied, the probability density calculation unit 31e adds 1 to nᵢ^{k} indicating the number of pieces of data in the section [E_{bin, i}, E_{bin, i+1}] for the value of temperature parameter set for the replica with replica number=k (step S56).

After step S56 or when it is determined that E_{bin, i}≤Eⱼ≤E_{bin, i+1} is not satisfied, the probability density calculation unit 31e determines whether i=N_{bin} is satisfied (step S57). When it is determined that i=N_{bin} is not satisfied, the probability density calculation unit 31e adds 1 to i (step S58) and repeats the processing from step S55.

When it is determined that i=N_{bin} is satisfied, the probability density calculation unit 31e determines whether j=N_{data} is satisfied (step S59). When it is determined that j=N_{data} is not satisfied, the probability density calculation unit 31e adds 1 to j (step S60) and repeats the processing from step S54.

When it is determined that j=N_{data} is satisfied, the probability density calculation unit 31e determines whether k=N_{replica} is satisfied (step S61). When it is determined that k=N_{replica} is not satisfied, the probability density calculation unit 31e adds 1 to k (step S62) and repeats the processing from step S53.

When it is determined that k=N_{replica} is satisfied, the probability density calculation unit 3e sets k=1 (step S63) and i=0 (step S64).

After that, the probability density calculation unit 31e updates nᵢ^{k} obtained by the processing up to step S62 with nᵢ^{k}/N_{data} (step S65).

The probability density calculation unit 31e determines whether i=N_{bin} is satisfied (step S66). When it is determined that i=N_{bin} is not satisfied, the probability density calculation unit 31e adds 1 to i (step S67) and repeats the processing from step S65.

When it is determined that i=N_{bin} is satisfied, the probability density calculation unit 31e determines whether k=N_{replica} is satisfied (step S68). When it is determined that k=N_{replica} is not satisfied, the probability density calculation unit 31e adds 1 to k (step S69) and repeats the processing from step S64.

When it is determined that k=N_{replica} is satisfied, the probability density calculation unit 31e ends the probability density calculation processing.

The flow of processing illustrated in FIG. 19 is an example, and the order of the processing may be changed as appropriate.

From nᵢ^{k} obtained by the above-described processing, probability density used for calculating an exchange probability (Pₑₓ) of replica exchange is obtained.

Eₘᵢₙ and Eₘₐₓ for each value of temperature parameter described above are updated at the time of main calculation, and the probability density is updated.

(Example of Replica Exchange Processing (Main Calculation))

In main calculation, MCMC calculation using an exponentiation type transition probability is performed in each of a plurality of replicas for which any of the values of a plurality of temperature parameters determined in the processing of step S12 is set.

When the above-described Eₘᵢₙ or Eₘₐₓ is updated during MCMC calculation, the probability density calculation unit 31e updates the above-described histogram by using the updated Eₘᵢₙ or Eₘₐₓ to update the probability density used to calculate an exchange probability.

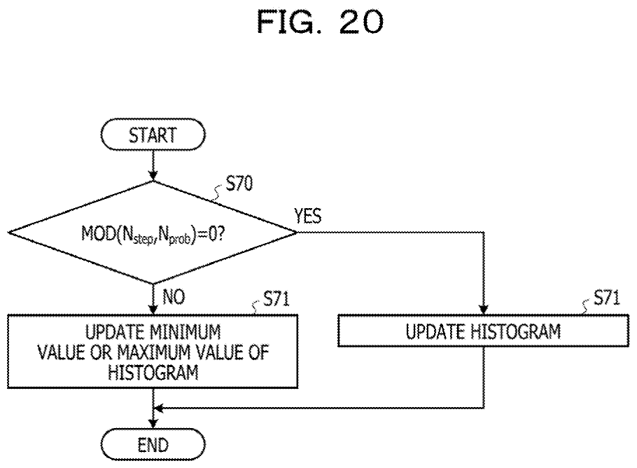

FIG. 20 is a flowchart illustrating an example of a flow of probability density update processing.

The probability density calculation unit 31e determines whether MOD(Nₛₜₑₚ, N_{prob})=0 is satisfied (step S70). Nₛₜₑₚ is the current number of times of main calculation (number of steps), and N_{prob} is the number of steps indicating the frequency of updating probability density. In the processing of step S70, it is determined whether Nₛₜₑₚ is a multiple of N_{prob}.

The frequency of updating the histogram may be low. N, is desirably set to be at least sufficiently larger than the number of times of calculation indicating the sampling frequency. For example, when sampling is performed once every 1000 times of main calculation, N_{prob} is set such that the histogram is updated once every 1000 times of sampling.

When it is determined that MOD(Nₛₜₑₚ, N_{prob})=0 is not satisfied, the probability density calculation unit 31e updates the minimum value (Eₘᵢₙ) or the maximum value (Eₘₐₓ) of the histogram by the processing described later (step S71) and ends the processing.

When it is determined that MOD(Nₛₜₑₚ, N_{prob})=0 is satisfied, the probability density calculation unit 31e updates the histogram (step S72) and ends the processing. In the processing of step S72, the latest Eₘᵢₙ or Eₘₐₓ at the timing of updating the histogram is used. When E_{Min} is updated, the probability density calculation unit 31e updates only the section [E_{bin, 0}, E_{bin, 1},] in the histogram. When Eₘₐₓ is updated, the probability density calculation unit 31e updates only the section [E_{bin, N-1}, E_{bin, N}] in the histogram. This makes it possible to reduce the amount of calculation as compared with the case where the entire histogram is updated.

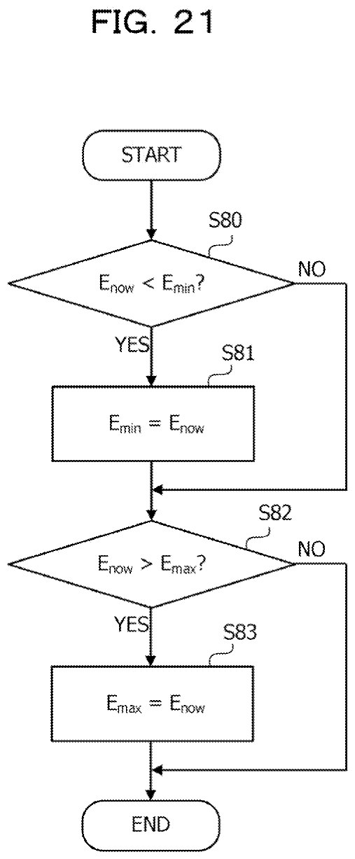

FIG. 21 is a flowchart illustrating an example of a flow of update processing of Eₘᵢₙ and Eₘₐₓ.

The probability density calculation unit 31e performs the following processing each time a state transition occurs by MCMC calculation in each replica.

The probability density calculation unit 31e determines whether energy (E_{now}) corresponding to the value of the current state variable obtained during the repeated calculation of MCMC calculation satisfies E_{now}<Eₘᵢₙ (step S80).

When it is determined that E_{now}<Eₘᵢₙ is satisfied, the probability density calculation unit 31e updates Eₘᵢₙ to E_{now} (step S81). After the processing of step S81 or when it is determined that E_{now}<Eₘᵢₙ is not satisfied, the probability density calculation unit 31e determines whether E_{now}>Eₘᵢₙ is satisfied (step S82).

When it is determined that E_{now}>Eₘₐₓ is satisfied, the probability density calculation unit 31e updates Eₘₐₓ to E_{now} (step S83). After the processing of step S83 or when it is determined that E_{now}>Eₘₐₓ is not satisfied, the probability density calculation unit 31e ends the update processing of Eₘᵢₙ and Eₘₐₓ.

The flow of processing illustrated in FIG. 21 is an example, and the order of the processing may be changed as appropriate.

By performing the probability density update processing as illustrated in FIG. 20 and FIG. 21, as the current number of times of main calculation increases, the accuracy of sampling probability density also increases.

In main calculation, the replica exchange calculation unit 31f exchanges the values of temperature parameter between replicas based on the exchange probability of equation (29) for each Nₑₓ indicating the replica exchange frequency. Instead of exchanging the values of temperature parameter, states (the values of N state variables) may be exchanged.

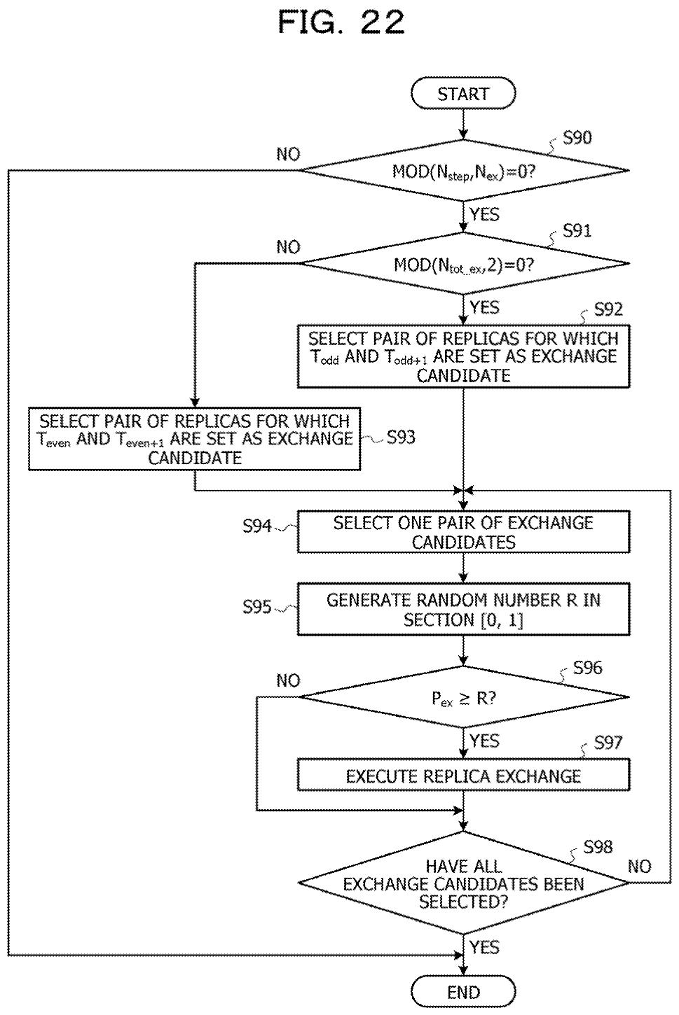

FIG. 22 is a flowchart illustrating an example of a flow of replica exchange processing.

The replica exchange calculation unit 31f determines whether MOD(Nₛₜₑₚ, Nₑₓ)=0 is satisfied (step S90). In the processing of step S90, it is determined whether Nₛₜₑₚ, which is the current number of times of calculation, is a multiple of Nₑₓ, which is the replica exchange frequency.

When it is determined that MOD(Nₛₜₑₚ, Nₑₓ)=0 is satisfied, the replica exchange calculation unit 31f determines whether MOD(N_{tot_ex}, 2)=0 is satisfied (step S91). When it is determined that MOD(Nₛₜₑₚ, Nₑₓ)=0 is not satisfied, the replica exchange calculation unit 31f ends the replica exchange processing. In the processing of step S91, it is determined whether N_{tot_ex} indicating the current number of times of replica exchange is an even number.

When it is determined that MOD(N_{tot_ex}, 2)=0 is satisfied, the replica exchange calculation unit 31f selects a pair of replicas for which Tom and T_{odd+1} are set, as an exchange candidate (step S92). T_{odd} indicates an odd-numbered value of temperature parameter when the values of temperature parameter (T) calculated in the processing of step S12 are arranged in ascending order. For example, it is assumed that the values of temperature parameters are arranged in the order of T₁, T₂, T₃, T₄, T₅, . . . . In this case, the pair of a replica for which T₁ is set and a replica for which T₂ is set, and the pair of a replica for which T₃ is set and a replica for which T₄ is set are included in the exchange candidates.

When it is determined that MOD(N_{tot_ex}, 2)=0 is not satisfied, the replica exchange calculation unit 31f selects a pair of replicas for which Tₑᵥₑₙ and Tₑᵥₑₙ₊₁ are set, as an exchange candidate (step S93). Tₑᵥₑₙ indicates an even-numbered value of temperature parameter when the values of temperature parameter (T) are arranged in ascending order. For example, it is assumed that the values of temperature parameters are arranged in the order of T₁, T₂, T₃, T₄, T₅, . . . . In this case, the pair of a replica for which T₂ is set and a replica for which T₃ is set, and the pair of a replica for which T₄ is set and a replica for which T₅ is set are included in the exchange candidates.

Next, the replica exchange calculation unit 31f selects one pair of exchange candidates (step S94), and generates a random number R having a value in section [0, 1] (step S95). The replica exchange calculation unit 31f determines whether Pₑₓ, which is the exchange probability of equation (29), satisfies Pₑₓ≥R (step S96).

When it is determined that Pₑₓ≥R is satisfied, the replica exchange calculation unit 31f executes replica exchange by exchanging the set values of temperature parameter between the replicas of the selected pair (step S97).

After the processing of step S97 or when it is determined that Pₑₓ≥R is not satisfied, the replica exchange calculation unit 31f determines whether all the exchange candidates selected in the processing of step S92 or step S93 have been selected in the processing of step S94 (step S98).

When it is determined that all the exchange candidates have not been selected, the replica exchange calculation unit 31f repeats the processing from step S94. When it is determined that all the exchange candidates have been selected, the replica exchange calculation unit 31f ends one time of the replica exchange processing.

The flow of processing illustrated in FIG. 22 is an example, and the order of the processing may be changed as appropriate.

The processing Illustrated in FIG. 22 is replica exchange processing by adjacent exchange. However, in a case where random exchange is performed, the processing may be changed such that a pair of replicas to be exchanged is selected by a random number. The calculation procedure after the pair is determined is the same as that in the case of adjacent exchange.

Supplement of the theoretical aspect will be described. The condition of detailed balance between any two replicas in equation (26) imposes the invariant distribution condition.

In a case where an exponentiation type transition probability is used, since the object is to solve the minimum value, the Invariant distribution condition does not have to be theoretically satisfied. However, in order to keep a sampling space steady, it is desirable to create certain distribution of an exponentiation type transition probability and impose a constraint condition such that the distribution is invariable. This is because, in preliminary calculation, probability density distribution for each value of temperature parameter is estimated, and according to the estimation, a plurality of values of temperature parameter and the number of replicas are defined so that sampling may be performed as widely as possible. It is implicitly assumed in this case that probability density distribution obtained in a replica for which the value of temperature parameter used for the estimation is set does not change by replica exchange. Therefore, in a minimum value solution problem, even when an exponentiation type transition probability is used, it is reasonable to impose the invariant distribution condition.

(Effect)

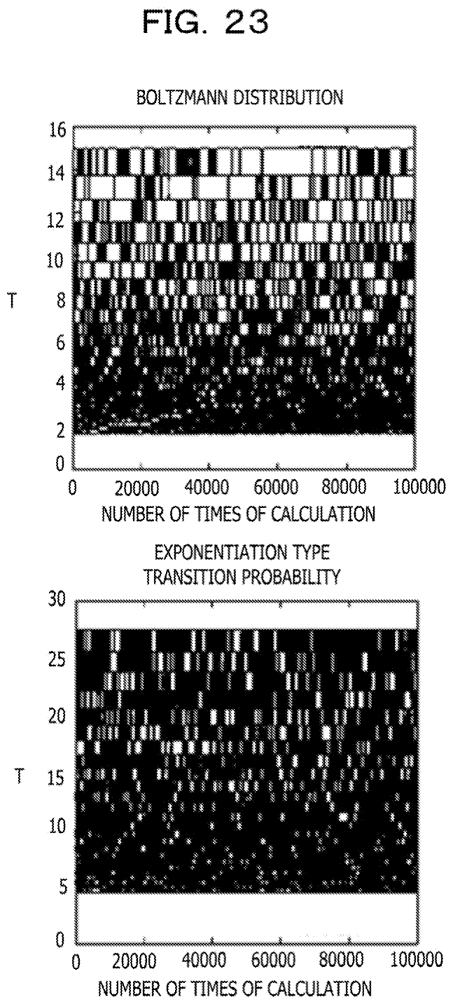

FIG. 23 is a diagram illustrating a state of exchanging the values of temperature parameter. The horizontal axis represents the number of times of calculation, and the vertical axis represents temperature parameter (T).

FIG. 23 illustrates a state of exchanging the values of temperature parameter in a case where replica exchange processing is performed using a transition probability based on the Boltzmann distribution, and a state of exchanging the values of temperature parameter in a case where replica exchange processing is performed using an exponentiation type transition probability (m=3).

A plurality of values of temperature parameter used in the replica exchange processing using a transition probability based on the Boltzmann distribution are those regarded as optimized. On the other hand, a plurality of values of temperature parameter in the replica exchange processing using an exponentiation type transition probability are not optimized. The reason is that, in order to verify the effect, the replica exchange processing using an exponentiation type transition probability is put under a more disadvantageous condition than the replica exchange processing using a transition probability based on the Boltzmann distribution.

For the values of a plurality of temperature parameters in the replica exchange processing using an exponentiation type transition probability, the minimum temperature is T=5, which is higher than the case of using a transition probability based on the Boltzmann distribution, because the value of m is a relatively large value, m=3. T=5 is a value that may be regarded as a sufficiently low temperature in the system of m=3 (in the case of m=1.001, T=about 0.1 is a value that may be regarded as a sufficiently low temperature).

In this manner, depending on the value of m, the value of temperature parameter that may be regarded as a sufficiently low temperature is determined as Tₘᵢₙ Indicating the minimum temperature, and the value of temperature parameter that may be regarded as a sufficiently high temperature is determined as Tₘₐₓ indicating the maximum temperature.

In FIG. 23, a line is displayed between adjacent temperatures for which replica exchange has been performed. When an exponentiation type transition probability is used, the lines are dense, and it may be seen that replica exchange is executed in all temperature zones. On the other hand, when a transition probability based on the Boltzmann distribution is used, the number of blanks increases toward the high temperature region, and it may be seen that less number of times of replica exchange is executed.

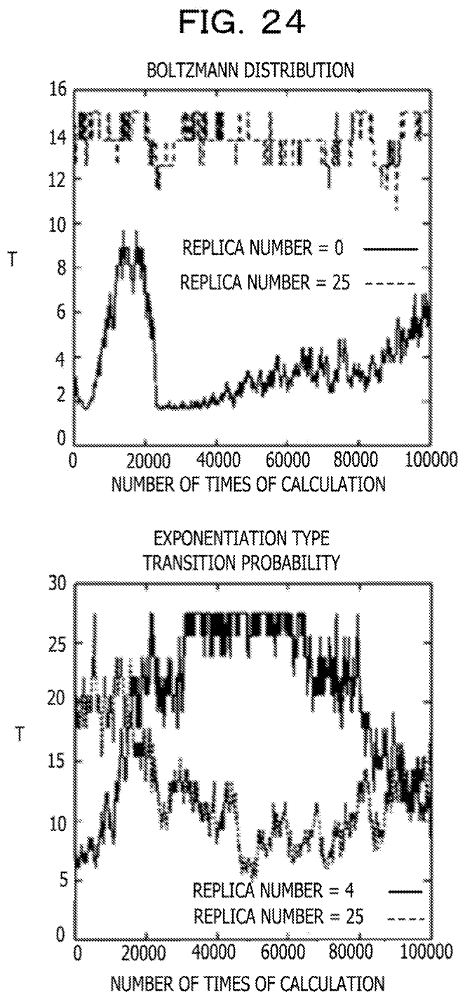

FIG. 24 is a diagram illustrating a change in the value of temperature parameter set for a replica. The horizontal axis represents the number of times of calculation (number of steps), and the vertical axis represents temperature parameter (T).

FIG. 24 illustrates a change in the value of temperature parameter set for the replica with replica number=0 and a change in the value of temperature parameter set for the replica with replica number=25 in the case where replica exchange processing is performed using a transition probability based on the Boltzmann distribution. FIG. 24 also illustrates a change in the value of temperature parameter set for the replica with replica number=4 and a change in the value of temperature parameter set for the replica with replica number=25 in the case where replica exchange processing is performed using an exponentiation type transition probability (m=3). The setting of the values of a plurality of temperature parameters is the same as in FIG. 23.

As illustrated in FIG. 24, when a transition probability based on the Boltzmann distribution is used, a relatively small value of temperature parameter is set for the replica with replica number=0, and a relatively large value of temperature parameter is set for the replica with replica number=25. For example, it may be seen that the low temperature region and the high temperature region are separated from each other. This is because it is difficult to adjust the value of temperature parameter in the vicinity of a phase transition point. An exchange probability exponentially decreases with respect to energy difference. There is a tendency that energy difference abruptly changes in the vicinity of a phase transition point and exchange is less likely to be performed. For this reason, it is difficult to efficiently exceed the vicinity of a phase transition point.

On the other hand, when an exponentiation type transition probability is used, it may be seen that the replicas may come and go between the low temperature region and the high temperature region even though the values of a plurality of temperature parameters are not optimized. This may be understood from the diagram of energy as a function of temperature parameter (T) in FIG. 5. When an exponentiation type transition probability is used, energy does not abruptly increase as a function of T as compared with the case of using a transition probability based on the Boltzmann distribution. For example, it is easier to perform replica exchange. This means that replica exchange using an exponentiation type transition probability is robust to the setting of temperature parameters.

While it may be seen that replica exchange processing using an exponentiation type transition probability is qualitatively useful as described above, in order to discuss a quantitative performance Improvement, tunneling time is adopted as a quantitative evaluation index. Tunneling time is time taken for a replica to go from Tₘᵢₙ to Tₘₐₓ and then from Tₘₐₓ back to Tₘᵢₙ. Conversely, time taken to go from Tₘₐₓ to Tₘᵢₙ and then from Tₘᵢₙ back to T_{R}m may be referred to as tunneling time.

The reason why this is a quantitative index is that the motivation for introducing the algorithm of replica exchange method is to efficiently change the global structure of an energy landscape by going through the high temperature region and increase the efficiency of sampling. It is considered that sampling would be efficiently performed if a replica may efficiently come and go between Tₘₐₓ and Tₘᵢₙ.

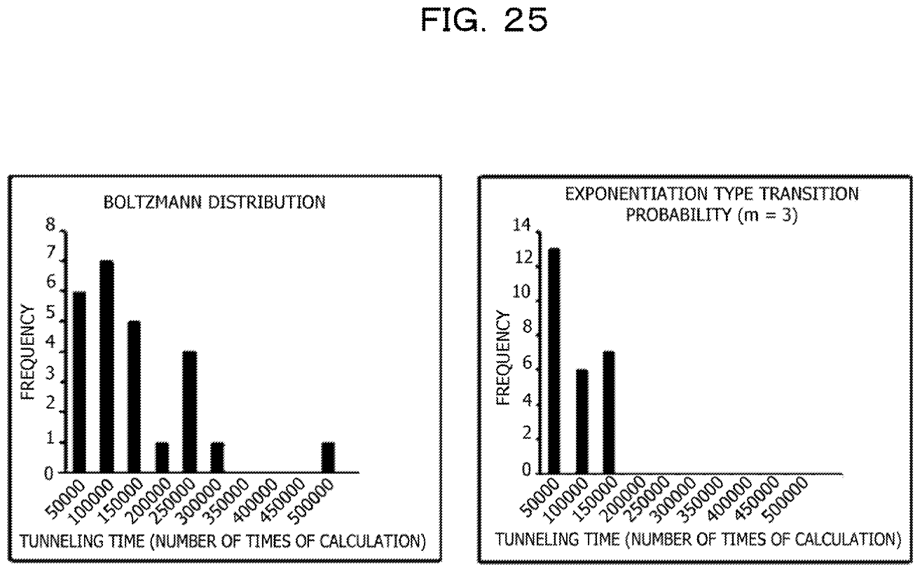

FIG. 25 is a diagram illustrating an example of a result of comparison of tunneling time in replica exchange processing between the case of using a transition probability based on the Boltzmann distribution and the case of using an exponentiation type transition probability. The horizontal axis represents tunneling time in terms of the number of times of calculation (number of steps), and the vertical axis represents frequency. An exponentiation type transition probability with m=3 is used.

In the case of replica exchange processing using a transition probability based on the Boltzmann distribution, the average value of tunneling time is approximately 150,000 steps. In contrast, in the case of replica exchange processing using an exponentiation type transition probability, the average value of tunneling time is approximately 92,000 steps. The ratio is about 1.63 times, which means that the performance is improved by about 63% based on the comparison in terms of tunneling time.

However, even when a transition probability based on the Boltzmann distribution is used, tunneling time may be shortened by repeatedly performing optimization if effort is not considered. The greatest advantage of adopting an exponentiation type transition probability is that since it is robust to the value of temperature parameter at the time of replica exchange processing, it is possible to reduce the effort for determining each value of temperature parameter. For example, it has significance in that a certain level of performance may be achieved even when cutting corners, for it would be a lot of trouble determining every time the optimal value of temperature parameter for each problem. Even when the final calculation time by a calculator for obtaining a result is reduced to 1/10, the entire optimization may not be achieved if it takes ten times for the time of calculation and preparation for obtaining the optimal value of temperature parameter. Since the above-described method is a method in which replica exchange is robust to the value of temperature parameter once Tₘᵢₙ and Tₘₐₓ of an exponentiation type transition probability are determined, relatively good performance may be achieved even when setting is inaccurate. This is because the factor that degrades the efficiency of replica exchange is intentionally removed.

As described above, the above-described processing may be realized by causing the information processing apparatus 20 to execute a program.

The program may be recorded on a computer-readable recording medium (for example, the recording medium 26a). As the recording medium, for example, a magnetic disk, an optical disk, a magneto-optical disk, a semiconductor memory, or the like may be used. The magnetic disk includes an FD and an HDD. The optical disk includes a CD, a CD-recordable (R)/rewritable (RW), a DVD, and a DVD-R/RW. The program may be recorded on a portable recording medium to be distributed. In this case, the program may be copied from the portable recording medium to another recording medium (for example, the HDD 23) to be executed.

Although an aspect of an optimization apparatus, a control method for the optimization apparatus and a control program for the optimization apparatus according to the present disclosure has been described based on the embodiments, such an aspect is a mere example and the present disclosure is not limited to the above description.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an optimization program for causing a computer to execute a process, the process comprising:
acquiring information on an evaluation function obtained by converting a problem;
determining values of a plurality of temperature parameters that are different from each other and used for solution processing of an optimal solution by a replica exchange method;
setting each of values of the plurality of temperature parameters to any one of a plurality of replicas; and
executing the solution processing by performing, for each of the plurality of replicas independently of each other, update processing of repeating update of any value of a plurality of state variables included in the evaluation function in accordance with a first transition probability that is obtained based on an amount of change in a value of the evaluation function due to a change in any value of the plurality of state variables and any value of the plurality of temperature parameters, and in which a change in a value of the evaluation function relative to a change in a value of temperature parameter is gentler than that in a case of using a second transition probability based on the Boltzmann distribution, and repeating exchange processing of exchanging, between the plurality of replicas, any values of the plurality of temperature parameters set for each of the plurality of replicas or values of the plurality of state variables in each of the plurality of replicas, in accordance with an exchange probability that satisfies an invariant distribution condition of probability distribution obtained by the first transition probability.

2. The non-transitory computer-readable recording medium storing an optimization program according to claim 1,
wherein the first transition probability is represented by a reciprocal of a value obtained by adding one to a product of the amount of change and any value of the plurality of temperature parameters to the power of m (m>1).

3. The non-transitory computer-readable recording medium storing an optimization program according to claim 2,
wherein the m is equal to or smaller than four.

4. The non-transitory computer-readable recording medium storing an optimization program according to claim 1 for causing a computer to execute a process of
determining a first value and a second value such that a sum of a value of the evaluation function that gives a vertex of first probability density distribution of a value of the evaluation function, which is obtained by the update processing using the first transition probability obtained based on the first value among values of the plurality of temperature parameters, and a value obtained by multiplying a standard deviation of the first probability density distribution by a predetermined coefficient is equal to a value obtained by subtracting, from a value of the evaluation function that gives a vertex of second probability density distribution of a value of the evaluation function, which is obtained by the update processing using the first transition probability obtained based on a second value among values of the plurality of temperature parameters, a value obtained by multiplying a standard deviation of the second probability density distribution by the coefficient.

5. The non-transitory computer-readable recording medium storing an optimization program according to claim 1,
wherein the exchange probability in the exchange processing performed between a first replica for which a third value that is one of values of the plurality of temperature parameters is set and a second replica for which a fourth value that is one of values of the plurality of temperature parameters is set among the plurality of replicas is represented by a ratio between a product of first probability density of a value of the evaluation function in the first replica and second probability density of a value of the evaluation function in the second replica before the exchange processing, and that after the exchange processing.

6. The non-transitory computer-readable recording medium storing an optimization program according to claim 5,
wherein the first probability density or the second probability density is calculated by approximation calculation using a histogram.

7. The non-transitory computer-readable recording medium storing an optimization program according to claim 5,
wherein when a minimum value or a maximum value of a value of the evaluation function in the first replica or the second replica is updated in the solution processing, the first probability density or the second probability density is updated based on an updated value of the minimum value or the maximum value.

8. An optimization method comprising:
acquiring, by a computer, information on an evaluation function obtained by converting a problem;
determining values of a plurality of temperature parameters that are different from each other and used for solution processing of an optimal solution by a replica exchange method;
setting each of values of the plurality of temperature parameters to any one of a plurality of replicas; and
executing the solution processing by performing, for each of the plurality of replicas independently of each other, update processing of repeating update of any value of a plurality of state variables included in the evaluation function in accordance with a first transition probability that is obtained based on an amount of change in a value of the evaluation function due to a change in any value of the plurality of state variables and any value of the plurality of temperature parameters, and in which a change in a value of the evaluation function relative to a change in a value of temperature parameter is gentler than that in a case of using a second transition probability based on the Boltzmann distribution, and repeating exchange processing of exchanging, between the plurality of replicas, any values of the plurality of temperature parameters set for each of the plurality of replicas or values of the plurality of state variables in each of the plurality of replicas, in accordance with an exchange probability that satisfies an invariant distribution condition of probability distribution obtained by the first transition probability.

9. An information processing apparatus comprising:
a memory; and
a processor coupled to the memory and configured to:
acquire information on an evaluation function obtained by converting a problem;
determine values of a plurality of temperature parameters that are different from each other and used for solution processing of an optimal solution by a replica exchange method;
set each of values of the plurality of temperature parameters to any one of a plurality of replicas; and
execute the solution processing by performing, for each of the plurality of replicas independently of each other, update processing of repeating update of any value of a plurality of state variables included in the evaluation function in accordance with a first transition probability that is obtained based on an amount of change in a value of the evaluation function due to a change in any value of the plurality of state variables and any value of the plurality of temperature parameters, and in which a change in a value of the evaluation function relative to a change in a value of temperature parameter is gentler than that in a case of using a second transition probability based on the Boltzmann distribution, and repeating exchange processing of exchanging, between the plurality of replicas, any values of the plurality of temperature parameters set for each of the plurality of replicas or values of the plurality of state variables in each of the plurality of replicas, in accordance with an exchange probability that satisfies an invariant distribution condition of probability distribution obtained by the first transition probability.
